(19) United States
(12) Patent Application Publication
(10) Pub. No.: US 2014/0101356 A1
(43) Pub. Date: Apr. 10, 2014

(54) TRANSMISSION DEVICE, TRANSMISSION SYSTEM, AND CONTROL METHOD FOR TRANSMISSION DEVICE

(71) Applicant: FUJITSU LIMITED, Kawasaki-shi (JP)

(72) Inventors: Kazumasa SONODA, Fukuoka (JP); Hideyuki KUDOU, Fukuoka (JP); Takahiro YAMAMOTO, Fukuoka (JP); Hiroo UCHIYAMA, Fukutsu (JP); Kozue FUKAMINATO, Fukuoka (JP)

(73) Assignee: FUJITSU LIMITED, Kawasaki-shi (JP)

(21) Appl. No.: 14/102,581

(22) Filed: Dec. 11, 2013

Related U.S. Application Data
(63) Continuation of application No. PCT/JP2011/064979, filed on Jun. 29, 2011.

(51) Int. Cl. G06F 13/40

(52) U.S. Cl. CPC G06F 13/4027
USPC 710/313

(57) ABSTRACT

A transmission device includes a plurality of transmitting units that transmit data to an opposing device via different paths, a determining unit that compares a first speed of an operation clock for the opposing device with a second speed of an operation clock for the transmission device, and an inserting unit that inserts, when the first speed is same as the second speed, first difference absorbing data that has a predetermined data length into the data to be transmitted by the transmitting units, that inserts, when the first speed is higher, second difference absorbing data that has a data length smaller than the predetermined data length into the data, and that inserts, when the second speed is higher, third difference absorbing data that has a data length greater than the predetermined data length into the data.

### CROSS-REFERENCE TO RELATED APPLICATION

This application is a continuation of International Application No. PCT/JP2011/064979, filed on Jun. 29, 2011, the entire contents of which are incorporated herein by reference.

### FIELD

The embodiments discussed herein are related to a transmission device, a transmission system, and a control method for the transmission device.

### BACKGROUND

There is a known conventional technology in which transmission devices transmit and receive data via multiple paths. An example of such a transmission device is that of the known technology associated with the Peripheral Component Interconnect express (PCIe) standard in which a transmission device is connected to opposing transmission devices via multiple paths and transmits and receives data by linking these multiple paths.

Because the transmission device that uses the technology associated with the PCIe standard operates at different clocks for each port that transmits and receives data, a difference is present between the clock frequency at which a port on the transmission side operates and the clock frequency at which a port on the reception side operates. When such a difference is present, because the transmitted and received data is lost or is read twice, the transmission device on the transmission side performs the following process.

Namely, the transmission device on the transmission side periodically creates fixed-length data called a skip (SKP) ordered set (hereinafter, referred to as a skip ordered set) and simultaneously inserts the created skip ordered set into the data that is to be transmitted via each path. Specifically, the transmission device on the transmission side inserts skip ordered set that has a length of four symbols and in which one “C (COM)” symbol and three “S (SKIP)” symbols are included. Then, the transmission device on the transmission side transmits, to an opposing transmission device, the data into which the skip ordered set is inserted.

In contrast, the transmission device on the reception side includes, for each transmission path, multiple elastic buffers that store therein the received data. Furthermore, the transmission device on the reception side stores, in each of the elastic buffers, the data received from the transmission device on the transmission side. When the transmission device on the reception side reads the data stored in each of the elastic buffers, in order to prevent overflow or underflow in each of the elastic buffers due to a difference in the clock frequency, the transmission device performs the following process for each elastic buffer.

Namely, when the amount of data stored in an elastic buffer is equal to or greater than a predetermined threshold, the transmission device on the reception side deletes one or some of the “S” symbols included in the skip ordered set that is inserted into the data. Furthermore, when the amount of data stored in an elastic buffer is equal to or greater than the predetermined threshold, the transmission device on the reception side reads a “S” symbol included in the skip ordered set that is inserted into the data, thereby adding a part of the skip ordered set.
Patent Document 1: Japanese Laid-open Patent Publication No. 2006-202281
Patent Document 2: Japanese Laid-open Patent Publication No. 2006-060507

However, in the above-described technology for periodically inserting a fixed-length of skip ordered set into all of the lanes, the deletion or the addition of the “S” symbol is independently performed for each elastic buffer. Consequently, the logic of the deskewing process, in which the tops of the data that are read from the elastic buffers are aligned, becomes complicated.

Specifically, because the transmission device on the reception side independently performs, for each elastic buffer, the addition or the deletion of the “S” symbol, if only the positions of the “C” symbols in the detected skip ordered sets are aligned, it is not difficult to perform the deskewing process on each of the data. Thus, the transmission device on the reception side detects a skip ordered set that is inserted into each of the data and then aligns the positions of the “C” symbols in the detected skip ordered sets. Then, the transmission device on the reception side performs a process of aligning the symbol lengths of each skip ordered set by comparing the symbol length of the skip ordered set that is inserted into each of the data and then deleting or adding one of the symbols included in the skip ordered set.

In the following, an example of a process performed by such a transmission device will be described with reference to the drawings. FIG. 22 is a schematic diagram illustrating an example of two conventional transmission devices. In the example illustrated in FIG. 22, it is assumed that a transmission device 50 on the transmission side and a transmission device 51 on the reception side each include eight ports #1 to #8 and transmit and receive data by linking eight serial transmission paths #1 to #8.

Furthermore, the data transmitted via the serial transmission paths #1 to #8 is referred to as data #1 to #8, respectively. Furthermore, it is assumed that the transmission device 51 includes elastic buffers (hereinafter, referred to as ESs) #1 to #8 that store therein the data #1 to #8 received via the serial transmission paths #1 to #8, respectively.

As illustrated at (A) in FIG. 22, the transmission device 50 transmits the data #1 to #8, in each of which a skip ordered set is inserted, from a SERializer/DESerializer (SerDes) to the transmission device 51 via the serial transmission paths #1 to #8, respectively. Here, as illustrated at (e) in FIG. 23, the transmission device 50 creates SKP Ins instructions that are instructions to insert skip ordered sets at predetermined time intervals. Then, as illustrated at (f) and (g) in FIG. 23, the transmission device 50 simultaneously inserts skip ordered sets into all of the data #1 to #8 into the boundaries of data that is located immediately after the SKP Ins. FIG. 23 is a schematic diagram illustrating an inserting process performed on conventional skip ordered sets.

Then, as illustrated at (B) in FIG. 22, the transmission device 51 receives, at different timings, the data #1 to #8 in which skip ordered sets are inserted and then the transmission device 51 stores the received data #1 to #8 in the ES#1 to #8, respectively. Thereafter, when the transmission device 51 reads the data #1 to #8 from the ESs #1 to #8, respectively, the transmission device 51 performs the following process.

Namely, as illustrated at (C) in FIG. 22, the transmission device 51 deletes or adds a part of the skip ordered set that is inserted into each of the data #1 to #8 in accordance with the amount of data stored in the ESs #1 to #8, respectively. Then, the transmission device 51 aligns the top positions of the skip ordered sets inserted into the read data #2 to #8 with the position of the skip ordered set in the data #1 and then makes the length of the skip ordered set inserted into each of the data #2 to #8 the same length as the skip ordered set in the data #1.

Specifically, in the example illustrated at (D) in FIG. 22, the transmission device 51 detects the skip ordered sets inserted into the data #2 and #8 and then compares the symbol lengths of the detected skip ordered sets with the symbol length of the skip ordered set that is inserted into the data #1. Then, the transmission device 51 determines that the length of the skip ordered set inserted into the data #2 is smaller than that inserted into the data #1 and determines that the length of the skip ordered set inserted into the data #8 is greater than that inserted into the data #1. Then, by reading a part of the skip ordered set twice that is inserted into the data #2, the transmission device 51 duplicates a skip ordered set. Furthermore, by deleting a part of the length of the skip ordered set inserted into the data #8, the transmission device 51 makes the length of each of the skip ordered sets inserted into the data #1, #2, and #8 the same.

FIG. 24 is a schematic diagram illustrating an example of a conventional deskewing process. For example, as illustrated at (h) in FIG. 24, the transmission device 51 deletes the “SKIP” symbol from the data #8. Then, as illustrated at (i) in FIG. 24, when the “COM” symbol in the skip ordered set is aligned, the top of the data is misaligned. Therefore, as illustrated at (j) in FIG. 24, the transmission device 51 adds a “SKIP” symbol when the transmission device 51 performs the deskewing process.

FIG. 25 is a schematic diagram illustrating another example of a conventional deskewing process. For example, as illustrated at (k) in FIG. 25, the transmission device 51 adds a “SKIP” symbol to the data #8. Then, as illustrated at (l) in FIG. 24, the top of the data is misaligned when the “COM” symbol in the skip ordered set is aligned. Therefore, as illustrated at (m) in FIG. 24, the transmission device 51 deletes the “SKIP” symbol when the transmission device 51 performs the deskewing process.

As described above, because the transmission device on the reception side performs a complicated deskewing process, the process delay becomes large. Furthermore, because the transmission device on the reception side includes, for each lane, a data buffer that is used to add or delete a symbol, the size of the circuit becomes large.

### SUMMARY

According to an aspect of an embodiment, a transmission device includes a plurality of transmitting units that transmit data to an opposing device via different paths, a determining unit that compares a first speed of an operation clock for the opposing device with a second speed of an operation clock for the transmission device to determine which of the operation clock speeds is higher, and an inserting unit that inserts, when the determining unit determines that the first speed is same as the second speed, first difference absorbing data that has a predetermined data length into the data to be transmitted by each of the transmitting units, that inserts, when the determining unit determines that the first speed is higher, second difference absorbing data that has a data length smaller than the predetermined data length into the data to be transmitted by each of the transmitting units, and that inserts, when the determining unit determines that the second speed is higher, third difference absorbing data that has a data length greater than the predetermined data length into the data to be transmitted by each of the transmitting units.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of an information processing system according to a first embodiment;

FIG. 2 is a schematic diagram illustrating an example of a transmission device according to the first embodiment;

FIG. 3 is a schematic diagram illustrating a skip inserting unit according to the first embodiment;

FIG. 4 is a schematic diagram illustrating a skip ordered set that is inserted when there is no difference between operation clocks;

FIG. 5 is a schematic diagram illustrating a skip ordered set that is inserted when the speed of an operation clock on the transmission side is high;

FIG. 6 is a schematic diagram illustrating a skip ordered set that is inserted when the speed of an operation clock on the reception side is high;

FIG. 7 is a schematic diagram illustrating the flow of a process performed by a slip detecting unit according to the first embodiment;

FIG. 8 is a schematic diagram illustrating values counted by the slip detecting unit according to the first embodiment;

FIG. 9 is a schematic diagram illustrating an example of a determining process performed by the slip detecting unit according to the first embodiment;

FIG. 10 is a schematic diagram illustrating an example of an elastic buffer according to the first embodiment;

FIG. 11A is a schematic diagram illustrating the flow of a process performed on a skip ordered set that is transmitted when there is no difference between operation clocks;

FIG. 11B is a schematic diagram illustrating the flow of a process performed on a skip ordered set that is inserted when the speed of an operation clock on the transmission side is higher than that on the reception side;

FIG. 11C is a schematic diagram illustrating the flow of a process performed on a skip ordered set that is inserted when the speed of an operation clock on the reception side is higher than that on the transmission side;

FIG. 12 is a schematic diagram illustrating a process in which the transmission device according to the first embodiment inserts a skip ordered set;

FIG. 13 is a schematic diagram illustrating a process performed on a skip ordered set by the transmission device on the reception side according to the first embodiment;

FIG. 14 is a schematic diagram illustrating an example of a skip ordered set that is inserted when the speed of an operation clock for a transmission device according to a second embodiment is higher than that at the transmission destination;

FIG. 15 is a schematic diagram illustrating an example of a skip ordered set that is inserted when the speed of an operation clock for the transmission device according to the second embodiment is lower than that at the transmission destination;

FIG. 16A is a schematic diagram illustrating an example of a skip ordered set that is inserted when the speed of an operation clock for the transmission device on the transmission side according to the second embodiment is higher than that for the transmission device on the reception side;

FIG. 16B is a schematic diagram illustrating an example of a skip ordered set that is inserted when the speed of an operation clock for the transmission device on the reception side is higher than that for the transmission device on the transmission side;

FIG. 17 is a schematic diagram illustrating an example of a skip ordered set that is inserted when an operation clock for the transmission device according to a third embodiment is higher than that at the transmission destination;

FIG. 18 is a schematic diagram illustrating an example of skip ordered set that is inserted when an operation clock for the transmission device according to the third embodiment is lower than that at the transmission destination;

FIG. 19A is a first schematic diagram illustrating how the transmission devices on the transmission side and the reception side according to the third embodiment perform a process on a skip ordered set;

FIG. 19B is a second schematic diagram illustrating how the transmission devices on the transmission side and the reception side according to the third embodiment perform a process on a skip ordered set;

FIG. 19C is a third schematic diagram illustrating how the transmission devices on the transmission side and the reception side according to the third embodiment perform a process on a skip ordered set;

FIG. 20 is a schematic diagram illustrating the flow of a process performed by the transmission device on the reception side according to the third embodiment;

FIG. 21 is a schematic diagram illustrating the flow of a process performed by the transmission device on the transmission side according to the third embodiment;

FIG. 22 is a schematic diagram illustrating an example of conventional transmission devices;

FIG. 23 is a schematic diagram illustrating an inserting process performed on conventional skip ordered sets;

FIG. 24 is a schematic diagram illustrating an example of a conventional deskewing process; and

FIG. 25 is a schematic diagram illustrating another example of a conventional deskewing process.

### DESCRIPTION OF EMBODIMENTS

Preferred embodiments of the present invention will be explained with reference to accompanying drawings.

### [a] First Embodiment

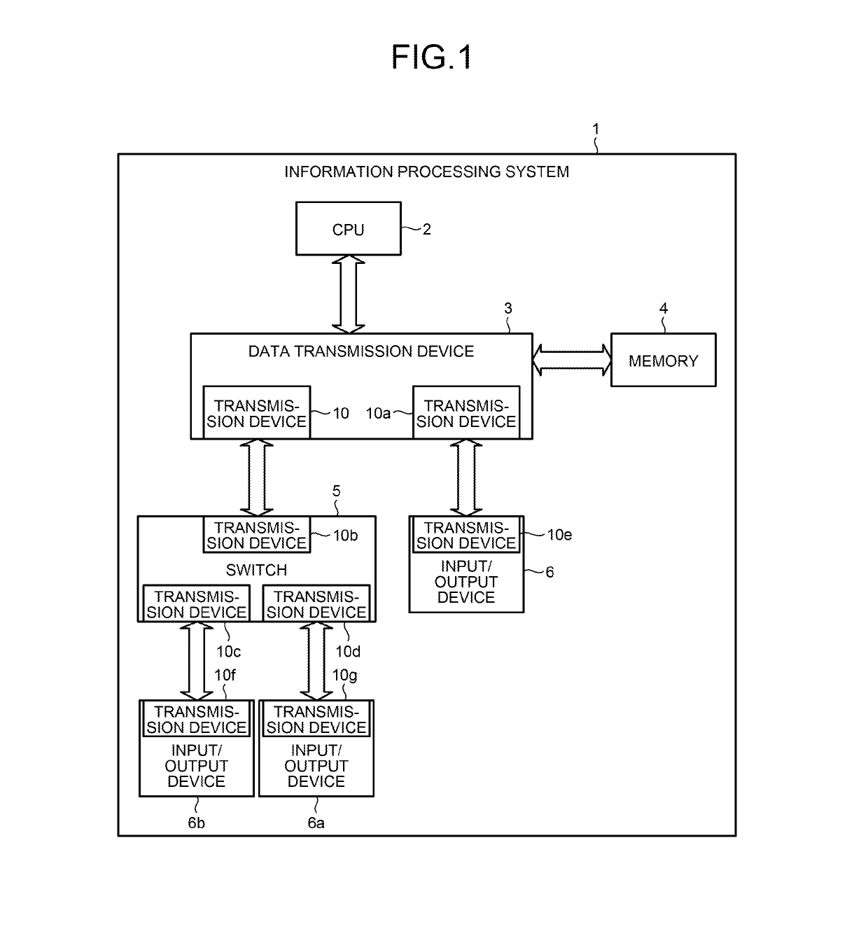

In a first embodiment described below, an example of an information processing system that includes a transmission device will be described with reference to FIG. 1. FIG. 1 is a schematic diagram illustrating an example of an information processing system according to a first embodiment.

As illustrated in FIG. 1, an information processing system 1 includes a central processing unit (CPU) 2, a data transmission device 3, a memory 4, a switch 5, and input/output devices 6 to 6b. The data transmission device 3 mentioned here is a data transmission device, such as a root complex conforming to the PCI Express (PCIe) standard. The input/output devices 6 to 6b mentioned here are termination points (end points).

Furthermore, the data transmission device 3 includes transmission devices 10 and 10a; the switch 5 includes transmission devices 10b to 10d; and the input/output devices 6 to 6b include transmission devices 10e to 10g. Furthermore, the data transmission device 3 is connected to the switch 5 via the transmission devices 10 and 10b and is connected to an input/output device 6 via the transmission devices 10a and 10e. The switch 5 is connected to the input/output device 6b via the transmission devices 10c and 10f and is connected to the input/output device 6a via the transmission devices 10d and 10g.

The transmission devices 10 to 10g are connected to each other via eight serial links and transmits and receives data by using a protocol conforming to the PCIe standard. Furthermore, each of the transmission devices 10 to 10g links the eight serial links, thereby transmitting and receiving data. It is assumed that the transmission devices 10a to 10g have the same function as that performed by the transmission device 10; therefore, descriptions of the transmission devices 10a to 10g will be omitted.

In the following, an example of the transmission device 10 will be described with reference to the drawings. In the following, a description will be given, as an example, with the assumption that the transmission device 10 and the transmission device 10b transmit and receive data. Furthermore, it is assumed that the data transmitted to the transmission device 10b by the transmission device 10 are transmission data #1 to #8 and it is assumed that the data received from the transmission device 10b by the transmission device 10 are reception data #1 to #8.

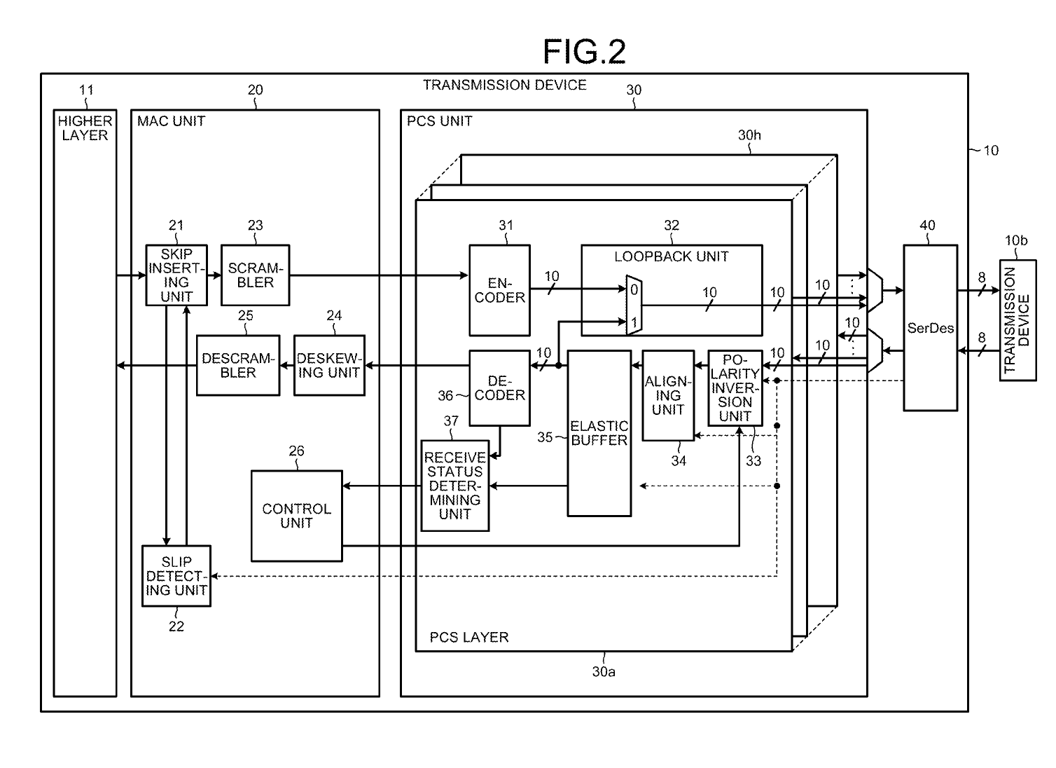

FIG. 2 is a schematic diagram illustrating an example of a transmission device according to the first embodiment. In the example illustrated in FIG. 2, the transmission device 10 includes a higher layer 11 that sends a transmission/reception request for data and a MAC unit 20 that performs a process on a media access control (MAC) layer. Furthermore, the transmission device 10 includes a physical coding sublayer (PCS) unit 30 that encodes data and a SERializer/DESerializer (SerDes) 40 that transmits and receives data.

The MAC unit 20 includes a skip inserting unit 21, a scrambler 23, a slip detecting unit 22, a deskewing unit 24, a descrambler 25, and a control unit 26. The PCS unit 30 includes eight PCS layers 30a to 30h. The PCS layer 30a includes an encoder 31, a loopback unit 32, a polarity inversion unit 33, an aligning unit 34, an elastic buffer 35, a decoder 36, and a receive status determining unit 37. It is assumed that each of the PCS layers 30a to 30h performs the same process; therefore, descriptions of the PCS layers 30b to 30h other than the PCS layer 30a will be omitted.

The skip inserting unit 21 receives the transmission data #1 to #8 that is transmitted from the higher layer 11 to the transmission device 10b. The skip inserting unit 21 inserts, into the received data, a skip ordered set by which a difference between the transmission device 10 and the transmission device 10b is absorbed. Then, the skip inserting unit 21 transmits, to the scrambler 23, the data into which the skip ordered set is inserted.

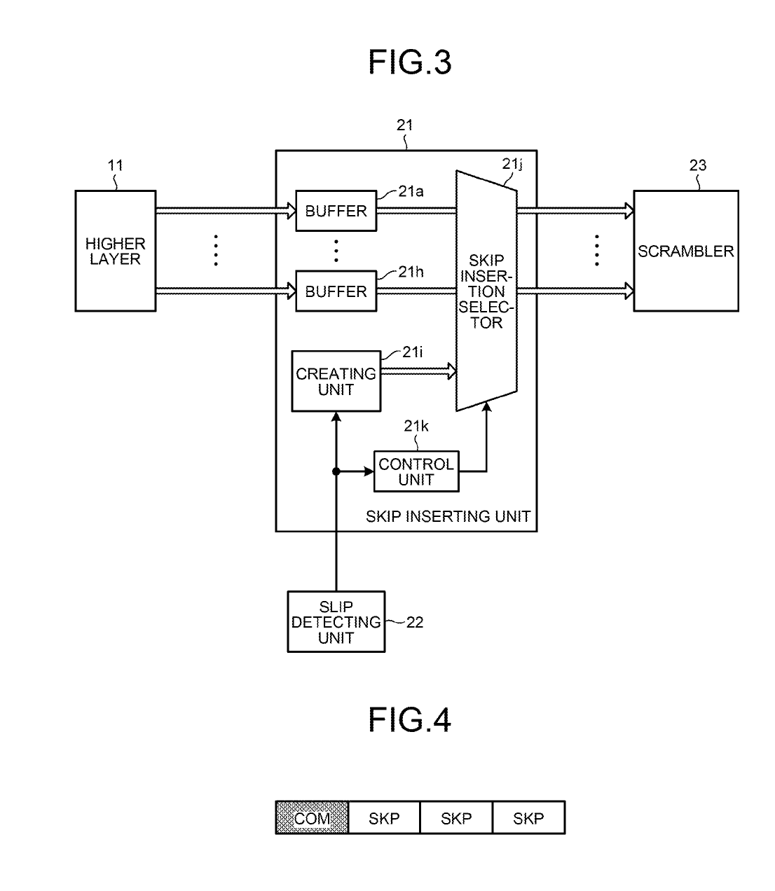

In the following, a description will be specifically given of a process for inserting a skip ordered set into data performed by the skip inserting unit 21. FIG. 3 is a schematic diagram illustrating a skip inserting unit according to the first embodiment. In the example illustrated in FIG. 3, the skip inserting unit 21 includes multiple buffers 21a to 21h, a creating unit 21i, a control unit 21k, and a skip insertion selector 21j.

The buffers 21a to 21h are First In First Out (FIFO) buffers and receive the transmission data #1 to #8, respectively, from the higher layer 11. Then, the buffers 21a to 21h transmit the received transmission data #1 to #8, respectively, to the skip insertion selector 21j. The creating unit 21i creates a skip ordered set that is stored in each of the transmission data #1 to #8 in accordance with the frequency of the operation clock for the transmission device 10 and the frequency of the operation clock for the transmission device 10b.

Specifically, the creating unit 21i receives, from the slip detecting unit 22, a notification that the speed of the operation clock for the transmission device 10 is high, a notification that the speed of the operation clock for the transmission device 10b is high, or a notification that there is no difference between the operation clocks. When the creating unit 21i receives one of the above notifications from the slip detecting unit 22, the creating unit 21i performs the following process, which will be described with reference to FIGS. 4 to 6.

FIG. 4 is a schematic diagram illustrating a skip ordered set that is inserted when there is no difference between operation clocks. When the creating unit 21i receives a notification from the slip detecting unit 22 indicating that there is no difference between operation clocks, the creating unit 21i performs the following process. Namely, as illustrated in FIG. 4, the creating unit 21i creates a skip ordered set in which one “COM” symbol and three “SKIP” (hereinafter, represented as “SKP”) symbols are included and then transmits the created skip ordered set to the skip insertion selector 21j.

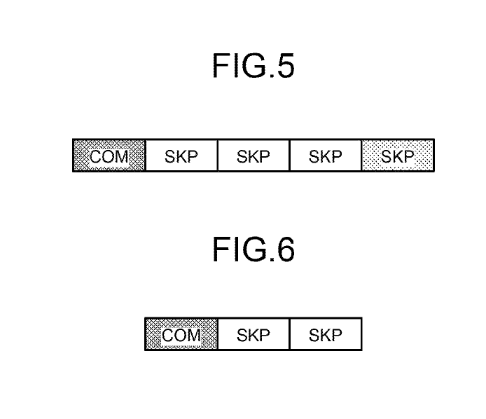

FIG. 5 is a schematic diagram illustrating a skip ordered set that is inserted when the speed of an operation clock on the transmission side is high. When the creating unit 21i receives a notification from the slip detecting unit 22 indicating that the speed of the operation clock for the transmission device 10 is high, the creating unit 21i creates, as illustrated in FIG. 5, a skip ordered set in which one “COM” symbol and four “SKP” symbols are included. Specifically, when the operation clock for the transmission device 10 is higher than that at the transmission device 10b, the creating unit 21i creates a skip ordered set that has a length equal or greater than the skip ordered set illustrated in FIG. 4. Then, the creating unit 21i transmits the created skip ordered set to the skip insertion selector 21j.

FIG. 6 is a schematic diagram illustrating a skip ordered set that is inserted when the speed of an operation clock on the reception side is high. When the creating unit 21i receives a notification from the slip detecting unit 22 indicating that the speed of the operation clock for the transmission device 10b is high, the creating unit 21i creates, as illustrated in FIG. 6, a skip ordered set in which one “COM” symbol and two “SKP” symbols are included. Specifically, when the speed of the operation clock for the transmission device 10b is higher than that at the transmission device 10, the creating unit 21i creates a skip ordered set that has a length equal or smaller than the skip ordered set illustrated in FIG. 4. Then, the creating unit 21i transmits the created skip ordered set to the skip insertion selector 21j.

A description will be given here by referring back to FIG. 3. The skip insertion selector 21j receives the transmission data #1 to #8 from the buffers 21a to 21h, respectively. Then, the skip insertion selector 21j transmits, to the scrambler 23, the received transmission data #1 to #8 via different paths. Furthermore, when the skip insertion selector 21j receives a notification from the control unit 21k indicating that a path will be changed, the skip insertion selector 21j receives the skip ordered set created by the creating unit 21i and then transmits the received skip ordered set to the scrambler 23 via each path.

Thereafter, when the skip insertion selector 21j receives a notification from the control unit 21k indicating that the path will be changed again, the skip insertion selector 21j again transmits the transmission data received from the buffers 21a to 21h to the scrambler 23. Specifically, by changing the path to the buffers 21a to 21h and the path to the creating unit 21i, the skip insertion selector 21j inserts each of the transmission data #1 to #8 and the skip ordered set created by the creating unit 21i.

The control unit 21k controls the skip insertion selector 21j. Specifically, the control unit 21k periodically creates a SKP Ins instruction that indicates when a skip ordered set is inserted and then the control unit 21k transmits the created SKP Ins instruction to the slip detecting unit 22. Furthermore, the control unit 21k receives a notification from the slip detecting unit 22 indicating that the speed of the operation clock for the transmission device 10 is high, a notification that the speed of the operation clock for the transmission device 10b is high, or a notification that there is no difference between operation clocks.

If the control unit 21k receives a notification that there is no difference between operation clocks, the control unit 21k performs the following process when the control unit 21k creates a SKP Ins instruction. Namely, the control unit 21k transmits a notification to the skip insertion selector 21j indicating that a path will be changed. After a time period for which the creating unit 21i transmits a skip ordered set that has a length of four symbols has elapsed, the control unit 21k transmits a notification to the skip insertion selector 21j indicating that the path will be changed again.

Furthermore, when the control unit 21k receives a notification that the speed of the operation clock for the transmission device 10 is high, the control unit 21k performs the following process when the control unit 21k creates a SKP Ins instruction. Namely, the control unit 21k transmits a notification to the skip insertion selector 21j indicating that a path will be changed. After a time period for which the creating unit 21i transmits a skip ordered set that has a length of 5 symbols has elapsed, the control unit 21k transmits a notification to the skip insertion selector 21j indicating that the path will be changed again.

Furthermore, when the control unit 21k receives a notification indicating that the speed of the operation clock for the transmission device 10b is high, the control unit 21k performs the following process when the control unit 21k creates a SKP Ins instruction. Namely, the control unit 21k transmits a notification to the skip insertion selector 21j indicating that a path will be changed. After a time period for which the creating unit 21i transmits a skip ordered set that has a length of three symbols has elapsed, the control unit 21k transmits a notification to the skip insertion selector 21j indicating that the path will be changed again.

A description will be given here by referring back to FIG. 2. The slip detecting unit 22 compares the speed of the operation clock for the transmission device 10 with that for the transmission device 10b and then determines which operation clock speed is high. Specifically, the slip detecting unit 22 detects a slip that is due to a difference occurring between operation clocks for the transmission device 10 on the transmission side and the transmission device 10b on the reception side. More specifically, the slip detecting unit 22 acquires, from the SerDes 40, which will be described later, a recovery clock that is an operation clock for the transmission device 10b. Then, the slip detecting unit 22 compares the recovery clock with the operation clock for the transmission device 10.

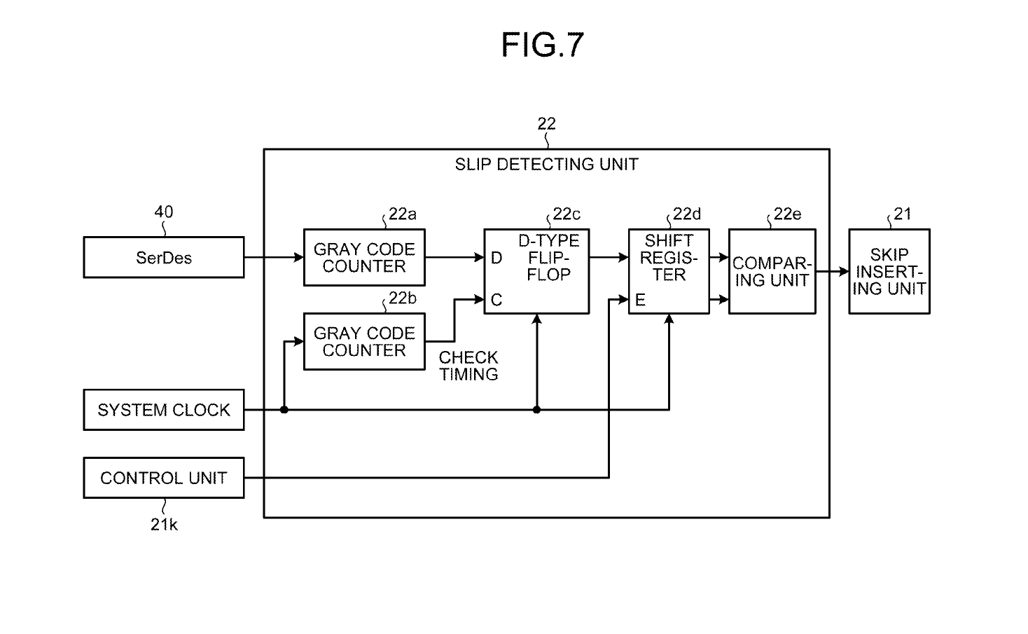

In the following, a description will be given of an example of a process in which the slip detecting unit 22 compares a recovery clock with an operation clock for the transmission device 10. FIG. 7 is a schematic diagram illustrating the flow of a process performed by a slip detecting unit according to the first embodiment. In the example illustrated in FIG. 7, the slip detecting unit 22 includes gray code counters 22a and 22b, a D-type flip-flop 22c, a shift register 22d, and a comparing unit 22e.

The gray code counter 22a receives a recovery clock from the SerDes 40. Then, the gray code counter 22a periodically counts the rising edge of the received recovery clock. For example, every time the rising edges of a recovery clock is input, the gray code counter 22a periodically counts the values “0” to “3”, e.g., “00 (0)”, “01 (1)”, “11 (2)”, “10 (3)”, and “00 (0)”. Then, the gray code counter 22a inputs the counted value to a D terminal of the flip-flop 22c.

The gray code counter 22b receives a system clock that is an operation clock for the transmission device 10. Then, the gray code counter 22b periodically counts the rising edge of the received system clock. For example, every time the rising edge of a system clock is input, the gray code counter 22b periodically counts the values “0” to “3”, e.g., “00 (0)”, “01 (1)”, “11 (2)”, “10 (3)”, and “00 (0)”. Then, when the counted value is “0”, the gray code counter 22b inputs a signal that indicates a check timing to a C terminal of the flip-flop 22c.

The flip-flop 22c operates as follows in accordance with the rising edge of the system clock. Specifically, at the timing at which the value that was input to the C terminal is shifted from “0” to “1”, the flip-flop 22c retains the value that is input to the D terminal and then outputs the retained value to the shift register 22d.

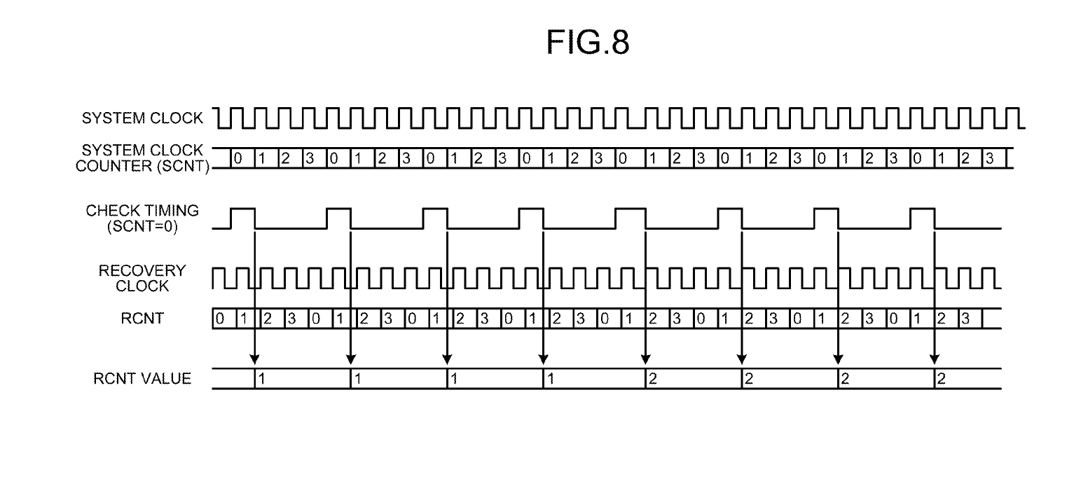

In the following, a value output from the flip-flop 22c will be described with reference to FIG. 8. FIG. 8 is a schematic diagram illustrating values counted by the slip detecting unit according to the first embodiment. FIG. 8 illustrates examples of the waveforms of the system clocks at the transmission device 10, the values counted by the gray code counter 22b (system clock counter: SCNT), and the signal indicating a check timing that is output by the gray code counter 22b. Furthermore, FIG. 8 illustrates waveforms of the recovery clocks, the values counted by the gray code counter 22a (recovery clock counter: RCNT), and the values of RCNT output by the flip-flop 22c.

As illustrated in FIG. 8, the gray code counter 22b inputs, to the flip-flop 22c, a signal that becomes “High” when SCNT is “0”. Furthermore, the gray code counter 22a counts the RCNT in accordance with the recovery clocks and inputs the RCNT to the flip-flop 22c.

Then, the flip-flop 22c retains the output of the gray code counter 22a, i.e., the RCNT, at the timing of the falling edge at which the check timing is shifted from “High” to “Low”. In the example illustrated in FIG. 8, the RCNT values retained by the flip-flop 22c is shifted to “1”, “1”, “1”, “1”, “2”, “2”, “2”, and “2”. Specifically, in the example illustrated in FIG. 8, because the speed of the operation clock for the transmission device 10b is higher than that for the transmission device 10, values of the RCNT that are periodically measured increases over time.

A description will be given here by referring back to FIG. 7. The shift register 22d is a register that retains therein data corresponding to a total of two outputs from the flip-flop 22c. Specifically, when the shift register 22d receives a SKP Ins instruction from the control unit 21k, the shift register 22d performs the following process. Namely, the shift register 22d stores therein an output from the flip-flop 22c in accordance with the rising edge of the system clock. Furthermore, the shift register 22d deletes the output that was output from the flip-flop 22c and that was output previously to the immediately previous output. Then, the shift register 22d outputs, to the comparing unit 22e, the stored output from the flip-flop 22c, i.e., the value that is output from the flip-flop 22c this time and the value that is output from the flip-flop 22c immediately previously.

The comparing unit 22e receives, from the shift register 22d, the value that is output from the flip-flop 22c immediately previously and the value that is output from the flip-flop 22c this time. Then, the comparing unit 22e compares the value that is output from the flip-flop 22c immediately previously with the value that is output from the flip-flop 22c this time and then determines whether the value output this time is greater than the value output immediately previously. When it is determined that the value output from the flip-flop 22c this time is greater than the value output from the flip-flop 22c immediately previously, the comparing unit 22e transmits a notification to the skip inserting unit 21 indicating that the speed of the operation clock for the transmission device 10b is high.

In contrast, when it is determined that the value output from the flip-flop 22c immediately previously is greater than that this time, the comparing unit 22e transmits a notification to the skip inserting unit 21 indicating that the speed of the operation clock for the transmission device 10 is high. Furthermore, when it is determined that the value output from the flip-flop 22c this time is the same as that immediately previously, the comparing unit 22e transmits a notification to the skip inserting unit 21 indicating that there is no difference between the operation clocks.

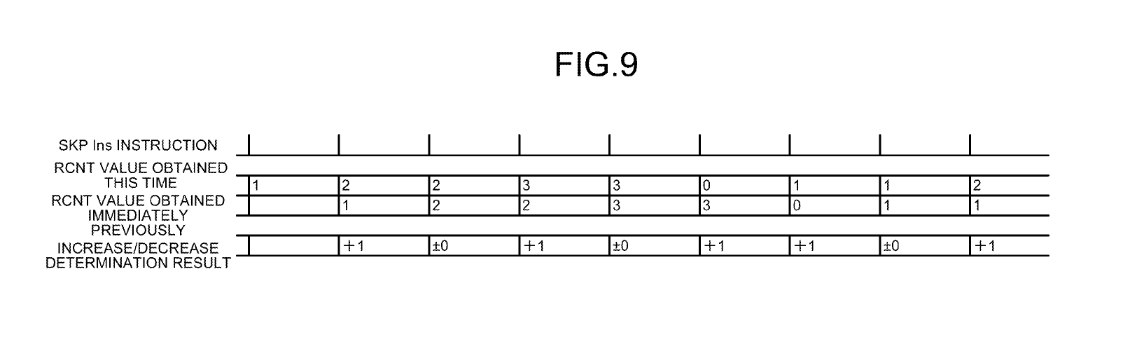

In the following, an example of a value stored in the shift register 22d and an example of a determining process performed by the comparing unit 22e will be described with reference to FIG. 9. FIG. 9 is a schematic diagram illustrating an example of a determining process performed by the slip detecting unit according to the first embodiment. FIG. 9 illustrates examples of the timing of the SKP Ins instructions, the outputs from the shift register 22d, i.e., the value of the RCNT obtained immediately previously and the value of the RCNT obtained this time, and the determination results performed by the comparing unit 22e.

In the example illustrated in FIG. 9, in accordance with the SKP Ins instructions, the shift register 22d outputs the RCNT value obtained this time and the RCNT value obtained immediately previously. Furthermore, in the example illustrated in FIG. 9, if the values output from the shift register 22d are represented by, for example, “this time RCNT value and immediately previous RCNT value”, the result will be as follows. Namely, the values output from the shift register 22d are “1, null”, “2, 1”, “2, 2”, “3, 2”, “3, 3”, “0, 3”, “1, 0”, “1, 1”, and “2, 1”. Furthermore, “null” indicates a blank field.

Consequently, the comparing unit 22e determines that an increase or a decrease in the RCNT value obtained this time with respect to the RCNT value obtained immediately previously is “null”, “+1”, “±0”, “+1”, “±0”, “+1”, “+1”, “±0”, and “+1”. Then, when there is an increase or a decrease in the RCNT value obtained this time with respect to the RCNT value obtained immediately previously is a positive value, i.e., is “+1” in the example illustrated in FIG. 9, the comparing unit 22e outputs a notification that the speed of the operation clock for the transmission device 10b is high.

Furthermore, when the RCNT value immediately previously and the RCNT value at this time are the same, i.e., is “±0” in the example illustrated in FIG. 9, the comparing unit 22e outputs a notification that the operation clocks are the same. Furthermore, although not illustrated in FIG. 9, when an increase or a decrease in the RCNT value at this time with respect to the RCNT value at previous time is a negative value, for example, “−1”, the comparing unit 22e outputs the notification that the speed of the operation clock for the transmission device 10 is high.

In the PCIe standard, a difference of an operation clock is defined to be within “±300 ppm”. Consequently, when a clock difference on the transmission side is “−300 ppm” and when a clock difference on the reception side is “300 ppm”, a difference of “600 ppm” is present between both sides. When a difference of “600 ppm” is present, a slip occurs at about every 1666 cycles of an operation clock. When a slip occurs, if the speed of an operation clock for the transmission device on the transmission side is high, a data loss occurs in the transmission device on the reception side, whereas, if the speed of an operation clock for the transmission device on the reception side is high, duplication of data occurs in the transmission device on the reception side.

In order to avoid such a data loss or duplication due to a slip occurring, the transmission device 10 performs a difference absorbing process by using a skip ordered set. At this time, when the transmission device 10 performs the difference absorbing process by using a skip ordered set, the transmission device 10 needs to identify whether the operation clock for the transmission side or for the reception side is high, i.e., determine the direction of a slip and occurrence frequency of the slip. Consequently, by using the slip detecting unit 22, the transmission device 10 detects the direction of the slip and the occurrence frequency of the slipping.

A description will be given here by referring back to FIG. 2. The scrambler 23 performs a scrambling process. Specifically, the scrambler 23 performs a scrambling process on the transmission data #1 to #8 in each of which a skip ordered set is inserted by the skip inserting unit 21. Then, the scrambler 23 transmits, to the encoder 31, the transmission data #1 to #8 that have been subjected to the scrambling process. Specifically, the scrambler 23 transmits the transmission data #1 to #8 to the different encoders, i.e., the different PCS layers 30a to 30h, respectively.

The deskewing unit 24 performs a deskewing process on the data received from the PCS unit 30. Specifically, the deskewing unit 24 receives, from the PCS unit 30, multiple reception data #1 to #8. Then, the deskewing unit 24 performs, due to a transmission delay difference, a skewing process on transmission paths or performs, due to the difference between the processing timings in the elastic buffers 35, which will be described later, a deskewing process that absorbs a delay difference.

Specifically, the deskewing unit 24 detects skip ordered sets that are inserted into the received reception data #1 to #8. Then, from among the skip ordered sets inserted into the reception data #1 to #8, the deskewing unit 24 aligns the positions of the “COM” symbols. For example, the deskewing unit 24 detects the “COM” symbol in each of the reception data #1 to #8.

When the position of the “COM” symbol in the reception data #8 is behind the positions of the “COM” symbol of the reception data #1 to #7 by one symbol, the deskewing unit 24 delays the output of each of the reception data #1 to #7 by one symbol. Then, the deskewing unit 24 transmits, to the descrambler 25, all of the reception data #1 to #8 subjected to the deskewing process.

When the descrambler 25 receives the reception data #1 to #8 from the deskewing unit 24, the descrambler 25 performs the descrambling process on the received reception data #1 to #8. Then, the descrambler 25 transmits, to the higher layer 11, the reception data #1 to #8 that have been subjected to the descrambling.

The control unit 26 acquires a reception status related to the reception data #1 from the receive status determining unit 37 in the PCS unit 30. Then, on the basis of the acquired reception status, the control unit 26 determines whether the reception data #1 is correctly received. If it is determined that the reception data #1 is not correctly received, the control unit 26 transmits a polarity inversion instruction to the polarity inversion unit 33. Furthermore, because the control unit 26 has already received the reception status on the reception data #1 to #8 from each of the receive status determining units in the PCS layers 30a to 30h in the PCS unit 30, the control unit 26 independently transmits a polarity inversion instruction for each polarity inversion unit in the PCS layers 30a to 30h.

In the following, a description will be given here of a process performed by each unit and the SerDes 40 included in the PCS unit 30. The encoder 31 encodes the data, which was received from the scrambler 23, from 8-bit data to 10-bit data. This is performed by the SerDes 40 in order to acquire an operation clock for the transmission device 10b by using a technique, such as a clock data recovery (CDR) technique. Then, the encoder 31 transmits the encoded 10-bit data to the loopback unit 32.

The loopback unit 32 is a selecting unit that selects data that is to be transmitted to the transmission device 10b. Specifically, in addition to the transmission data #1, the data received from the transmission device 10b is input to the loopback unit 32. When the loopback unit 32 does not perform a loopback, the loopback unit 32 transmits, to the SerDes 40, the transmission data #1 that is encoded as the 10-bit data by the encoder 31.

Furthermore, when the loopback unit 32 receives an instruction to perform a loopback, the loopback unit 32 transmits, to the SerDes 40, the data that was read by the elastic buffer 35, which will be described later, i.e., the data that was received from the transmission device 10b via the serial link. An arbitrary method can be used for setting whether the loopback unit 32 performs a loopback process. Furthermore, in the following description, it is assumed that the data received from the transmission device 10b via the serial link is the reception data #1 to #8.

Furthermore, a description has been given of a process performed by the encoder 31 and the loopback unit 32 in the PCS layer 30a; however, it is assumed that the encoders and the loopback units included in the other PCS layers 30b to 30h also perform the same process.

The SerDes 40 receives, from each of the PCS layers 30a to 30h in the PCS unit 30, the transmission data #1 to #8 or receives the reception data #1 to #8 that are loop backed to the transmission device 10b. Then, the SerDes 40 converts the received transmission data #1 to #8 or the reception data #1 to #8 to serial data and then transmits the converted serial data to the transmission device 10b via different paths.

Furthermore, the SerDes 40 receives the reception data #1 to #8 from the transmission device 10b. Then, the SerDes 40 transmits the reception data #1 to #8 to the polarity inversion units in the PCS layers 30a to 30h. Furthermore, when the SerDes 40 receives the reception data #1 to #8 from the transmission device 10b, the SerDes 40 acquires an operation clock for the transmission device 10b by using a technique, such as a clock data recovery (CDR) technique.

Then, the SerDes 40 transmits the acquired operation clock as a recovery clock to the polarity inversion unit, the aligning unit, and the elastic buffer, which are included in each of the PCS layers 30a to 30h, and to the slip detecting unit 22, which is included in the MAC unit 20. For example, the SerDes 40 transmits the recovery clock to the polarity inversion unit 33, the aligning unit 34, the elastic buffer 35, and the slip detecting unit 22 in the PCS layer 30a.

The polarity inversion unit 33 is a polarity inversion device that operates in accordance with a recovery clock. When the polarity inversion unit 33 receives a polarity inversion instruction from the control unit 26, the polarity inversion unit 33 inverses the polarity of the reception data #1 received from the SerDes 40. Then, the polarity inversion unit 33 transmits the reception data #1 to the aligning unit 34.

The aligning unit 34 performs a process, in accordance with a recovery clock, for establishing symbol synchronization. Specifically, in order to store the reception data #1, which was received from the polarity inversion unit 33, in the elastic buffer 35, the aligning unit 34 aligns the data width of the reception data #1 with the data width of the data that is to be stored in the elastic buffer 35. Then, the aligning unit 34 transmits, to the elastic buffer 35, the reception data #1 whose data width is aligned.

The elastic buffer 35 is a buffer for changing between the clock for the transmission device 10b and that for the transmission device 10. Specifically, the elastic buffer 35 is a buffer that is used to absorb any difference between the operation clock for the transmission device 10 and the operation clock for the transmission device 10b. More specifically, because the transmission device 10 receives the reception data #1 to #8 in accordance with the operation clock for the transmission device 10b, the transmission device 10 temporarily stores the reception data #1 to #8 in the elastic buffer 35. Then, by reading the reception data #1 to #8 stored in the elastic buffer 35 by using the operation clock for the transmission device 10, the transmission device 10 changes clocks.

Furthermore, when storing the reception data #1 and reading the stored reception data #1, the elastic buffer 35 detects the skip ordered set that is inserted into the reception data #1. When the elastic buffer 35 detects a skip ordered set that has a length equal to or greater than four symbols, the elastic buffer 35 corrects the length of symbols in the detected skip ordered set to a length of four symbols and stores therein the reception data #1 in which the skip ordered set is corrected.

Furthermore, when reading the stored reception data #1, the elastic buffer 35 detects a skip ordered set that has a length equal to or less than four symbols. Then, the elastic buffer 35 corrects the length of symbols in the detected skip ordered set to a length of four symbols and transmits, to the decoder 36, the reception data #1 in which the skip ordered set is corrected.

Specifically, when the elastic buffer 35 stores therein the reception data #1, if the elastic buffer 35 detects a skip ordered set in which one “COM” symbol and four “SKP” symbols are included, the elastic buffer 35 deletes a single “SKP” symbol. Then, the elastic buffer 35 stores therein the reception data #1 into which a skip ordered set that includes therein one “COM” symbol and three “SKP” symbols is inserted.

Furthermore, when the elastic buffer 35 reads the reception data #1, if the elastic buffer 35 detects a skip ordered set in which one “COM” symbol and two “SKP” symbols are included, the elastic buffer 35 reads the “SKP” symbols twice, thus duplicating the symbols. Then, the elastic buffer 35 transmits, to the decoder 36, the reception data #1 into which the skip ordered set that includes therein one “COM” symbol and three “SKP” symbols is inserted.

As described above, when the elastic buffer 35 stores therein the reception data #1, if the elastic buffer 35 detects a skip ordered set that has a length equal to or greater than four symbols, the elastic buffer 35 corrects the detected skip ordered set to a skip ordered set that has a length of four symbols and then stores therein the reception data #1. Furthermore, when the elastic buffer 35 reads the reception data #1, if the elastic buffer 35 detects a skip ordered set that has a length equal to or less than four symbols, by reading the “SKP” symbols in the detected skip ordered set twice, the elastic buffer 35 corrects the detected skip ordered set to a skip ordered set that has a length of four symbols. Furthermore, the elastic buffer 35 transmits, to the receive status determining unit 37, the presence or absence of an error or the nature of the process for writing or reading the reception data #1.

The decoder 36 decodes the reception data #1 that is read from the elastic buffer 35 from 10-bit data to 8-bit data. Then, the decoder 36 transmits the decoded reception data #1 to the deskewing unit 24 in the MAC unit 20. Furthermore, the decoder 36 transmits, to the receive status determining unit 37, the presence or absence of an error in the decoding process.

Depending on the presence or absence of an error or the nature of the process for writing or reading the reception data #1 received from the elastic buffer 35 and the decoder 36, the receive status determining unit 37 determines whether the reception data #1 has been received normally. Then, the receive status determining unit 37 transmits the determination result as the reception status to the control unit 26 in the MAC unit 20.

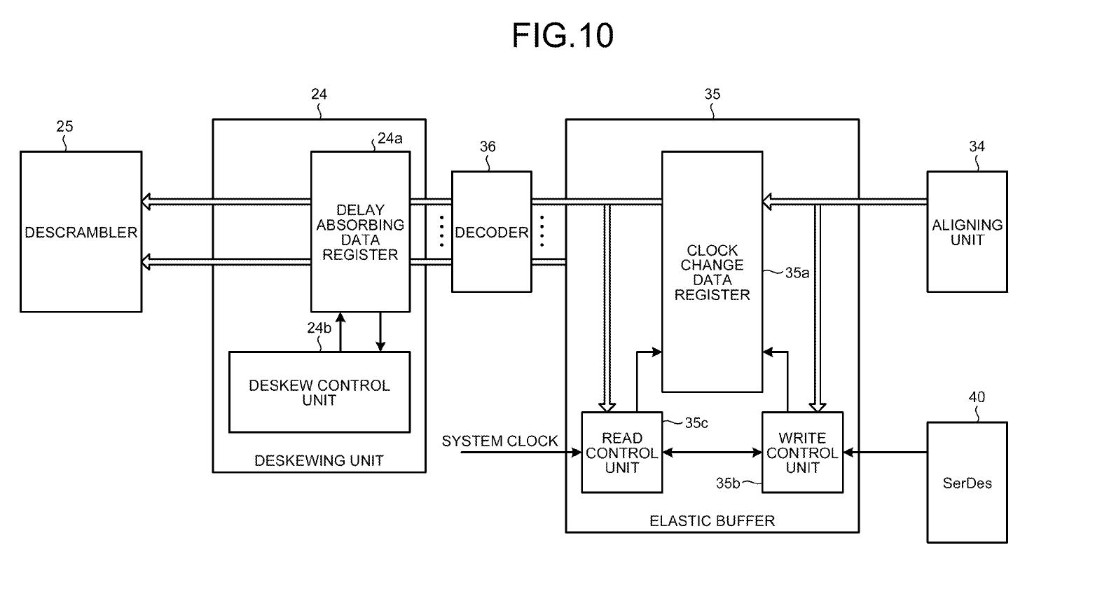

In the following, an example of a process performed by the elastic buffer 35 will be described with reference to FIG. 10. FIG. 10 is a schematic diagram illustrating an example of an elastic buffer according to the first embodiment. In the example illustrated in FIG. 10, a description will be given of the elastic buffer 35 and the decoder 36, which are included in the PCS layer 30a, and the deskewing unit 24, which is included in the MAC unit 20.

In the example illustrated in FIG. 10, the elastic buffer 35 includes a clock change data register 35a, a write control unit 35b, and a read control unit 35c. The clock change data register 35a is a register that stores therein the reception data #1 received from the aligning unit 34. The write control unit 35b is a control unit that controls, in accordance with the recovery clock received from the SerDes 40, the writing of the reception data #1 into the clock change data register 35a.

In this example, the write control unit 35b monitors the reception data #1 that is transmitted from the aligning unit 34 to the clock change data register 35a and detects a skip ordered set that has a length equal to or greater than four symbols. Then, when the write control unit 35b detects the skip ordered set that has a length equal to or greater than four symbols, the write control unit 35b discards the last symbol, i.e., the “SKP” symbol, instead of storing the last symbol in the clock change data register 35a.

Furthermore, the read control unit 35c is a control unit that controls, in accordance with the system clock for the transmission device 10, the reading of the reception data #1 from the clock change data register 35a. Specifically, the read control unit 35c detects, from the reception data #1 that is read from the clock change data register 35a, a skip ordered set that has a length equal to or less than three symbols.

When the read control unit 35c detects the skip ordered set that has that has a length equal to or less than three symbols, by reading the last “SKP” symbol in the detected skip ordered set twice, the read control unit 35c corrects the length of symbols in the detected skip ordered set to a length of four symbols. Then, the decoder 36 decodes the reception data #1 that has been read by the read control unit 35c to 8-bit data and then transmits the decoded data to the deskewing unit 24.

The deskewing unit 24 includes a delay absorbing data register 24a and a deskew control unit 24b. First, the delay absorbing data register 24a receives the reception data #1 to #8 from the PCS unit 30 and temporarily stores therein the reception data #1 to #8. Then, the deskew control unit 24b detects each of the “COM” symbols from the reception data #1 to #8 stored in the delay absorbing data register 24a. Then, the deskew control unit 24b aligns the positions of the detected “COM” symbols and then outputs the reception data #1 to #8.

For example, the deskew control unit 24b detects the positions of the “COM” symbols in the reception data #1 to #8 and then determines that the “COM” symbol in the skip ordered set in the reception data #2 is located at the end position. In such a case, the deskew control unit 24b delays the output timing of the other reception data #1 and #3 to #8. Then, the deskew control unit 24b controls the delay absorbing data register 24a such that the “COM” symbols in the other reception data #1 and #3 to #8 are output at the same time as the “COM” symbol in the skip ordered set in the reception data #2 is output.

The skip inserting unit 21, the slip detecting unit 22, the scrambler 23, the deskewing unit 24, the descrambler 25, the control unit 26, the encoder 31, the loopback unit 32, the polarity inversion unit 33, the aligning unit 34, the decoder 36, and the receive status determining unit 37 are, for example, electronic circuits. Examples of the electronic circuits used here include integrated circuits, such as application specific integrated circuits (ASICs) or field programmable gate arrays (FPGAs), central processing units (CPUs), or micro processing units (MPUs).

Furthermore, the elastic buffer 35 is implemented by the combination of a semiconductor memory device, such as a random access memory (RAM), read only memory (ROM), and a flash memory, and an electronic circuit or the like.

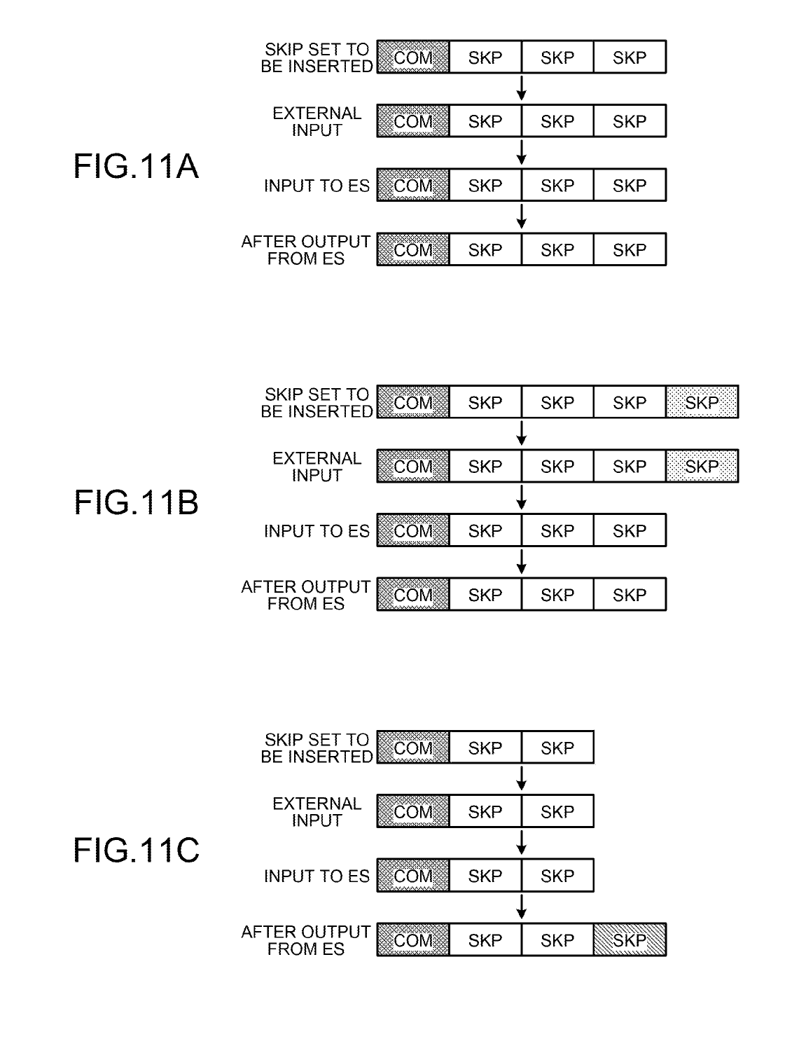

In the following, how the skip ordered set that is inserted by the transmission device 10 is processed by the transmission device 10b will be described with reference to FIGS. 11A to 11C. In the description below, a description will be given with the assumption that the transmission device 10b performs the same process as that performed by the transmission device 10.

First, how a skip ordered set that has a length of four symbols and is transmitted when there is no difference between operation clocks will be described with reference to FIG. 11A. FIG. 11A is a schematic diagram illustrating the flow of a process performed on a skip ordered set that is transmitted when there is no difference between operation clocks. FIG. 11A illustrates the skip ordered set that is to be inserted, the skip ordered set that is received by the transmission device 10b, the skip ordered set that is stored in an elastic buffer by the transmission device 10b, and the skip ordered set that is read from an elastic buffer by the transmission device 10b.

In the example illustrated in FIG. 11A, the transmission device 10 inserts, into the transmission data #1 to #8, a skip ordered set in which one “COM” symbol and three “SKP” symbols are included. In such a case, the transmission device 10b does not correct the skip ordered set that is inserted into each of the transmission data #1 to #8 but does perform writing and reading of the transmission data #1 to #8 to the elastic buffer.

In the following, how the process is performed on a skip ordered set that has a symbol length of 5 symbols and which is inserted when the speed of the operation clock for the transmission device 10 is higher than that for the transmission device 10b will be described with reference to FIG. 11B. FIG. 11B is a schematic diagram illustrating the flow of a process performed on a skip ordered set that is inserted when the speed of an operation clock on the transmission side is higher than that on the reception side. In the example illustrated in FIG. 11B, the transmission device 10 inserts, into the transmission data #1 to #8, a skip ordered set in which one “COM” symbol and four “SKP” symbols are included.

In such a case, when the transmission device 10b stores the transmission data #1 to #8 in an elastic buffer, by discarding the last “SKP” symbol, the transmission device 10b corrects the length of symbols in the inserted skip ordered set to a length of four symbols.

In the following, how the process is performed on a skip ordered set that has a symbol length of three symbols and which is inserted when the speed of the operation clock for the transmission device 10b is higher than that for the transmission device 10 will be described with reference to FIG. 11C. FIG. 11C is a schematic diagram illustrating the flow of a process performed on a skip ordered set that is inserted when the speed of an operation clock on the reception side is higher than that on the transmission side. In the example illustrated in FIG. 11C, the transmission device 10 inserts, into the transmission data #1 to #8, a skip ordered set in which one “COM” symbol and two “SKP” symbols are included.

In such a case, when the transmission device 10b reads the transmission data #1 to #8 from an elastic buffer, the transmission device 10b reads the last “SKP” symbol twice, thereby duplicating the “SKP” symbol and correcting the symbol length of an inserted skip ordered set to a symbol length of an inserted skip ordered set that has a symbol length of four symbols.

As described above, when the speed of the operation clock for the transmission device 10 is the same as that for the transmission device 10b, the transmission device 10 inserts, as a normal skip ordered set, a skip ordered set that has a symbol length of four symbols into the transmission data #1 to #8. Furthermore, when the speed of the operation clock for the transmission device 10 is higher than that for the transmission device 10b, the transmission device 10 inserts, into the transmission data #1 to #8, a skip ordered set that has a symbol length of five symbols and that is longer than the normal skip ordered set.

Furthermore, when the speed of the operation clock for the transmission device 10b is higher than that for the transmission device 10, the transmission device 10 inserts, into the transmission data #1 to #8, a skip ordered set that has a symbol length of three symbols and that is shorter than the normal skip ordered set. Consequently, the transmission device 10 can absorb the clock difference between the transmission device 10 and the transmission device 10b.

Furthermore, instead of correcting, for each of the transmission data #1 to #8, the symbol length of a skip ordered set, the transmission device 10b corrects the length of a skip ordered set to the normal length. Consequently, because the transmission device 10 easily corrects the symbol length of a skip ordered set, the transmission device 10 simplifies the logic of the deskewing process.

Furthermore, the transmission device 10 does not need to correct the length of symbols in a skip ordered set when the transmission device 10b performs the deskewing process. Consequently, the transmission device 10 does not need the data register that is used to correct the length of symbols. Thus, the transmission device 10 can reduce the size of the circuit that is used to perform the deskewing process.

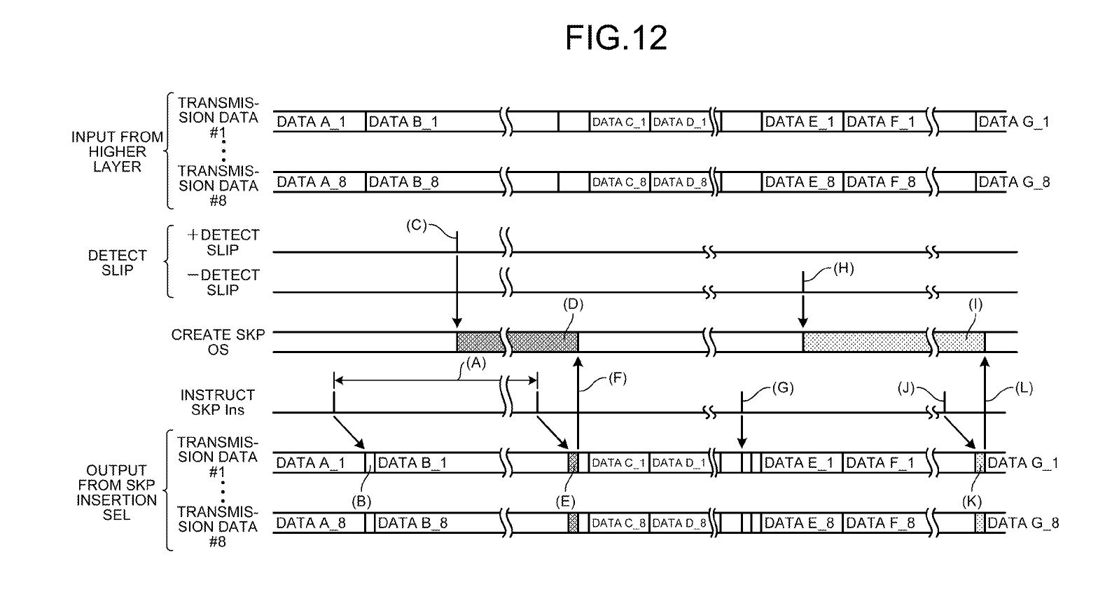

In the following, the flow of a process for inserting a skip ordered set performed by the transmission device 10 will be described with reference to FIG. 12. FIG. 12 is a schematic diagram illustrating a process in which the transmission device according to the first embodiment inserts a skip ordered set. FIG. 12 illustrates examples of data A_{—}1 to G_{—}8, which are the content of the transmission data #1 to #8 transmitted from the higher layer 11 to the MAC unit 20; the slip detected by the slip detecting unit 22; the skip ordered set to be inserted; and the timing of the SKP Ins instruction. Furthermore, FIG. 12 illustrates examples of the transmission data #1 to #8 into each of which a skip ordered set is inserted.

In the example illustrated in FIG. 12, the transmission data #1 to #8 are input from the higher layer 11. Furthermore, as illustrated at (A) in FIG. 12, the skip inserting unit 21 creates an SKP Ins instruction at about 1500-symbol intervals. Consequently, as illustrated at (B) in FIG. 12, the transmission device 10 simultaneously inserts the skip ordered sets, each of which has the normal length of four symbols, into the boundaries between the data A_{—}1 to A_{—}8 and the data B_{—}1 to B_{—}8, respectively.

At this point, as illustrated at (C) in FIG. 12, when a positive slip is detected, i.e., the speed of the operation clock for the transmission device 10 is higher than that for the transmission device 10b, the transmission device 10 performs the following process. Namely, as illustrated at (D) in FIG. 12, the transmission device 10 creates a skip ordered set that has a length of five symbols and that is longer than the normal skip ordered set. Then, as illustrated at (E) in FIG. 12, after a SKP Ins instruction is created, the transmission device 10 inserts the created skip ordered set between the data B_{—}1 to _{—}8 and the data C_{—}1 to C_{—}8, respectively, i.e., these insertions are made at the boundaries of the data. Furthermore, as illustrated at (F) in FIG. 12, when the transmission device 10 inserts the skip ordered set that has a length of five symbols, the transmission device 10 creates a skip ordered set that has a normal length of four symbols.

Then, as illustrated at (G) in FIG. 12, when the SKP Ins instruction is created, because the skip ordered set that has the normal symbol length of four symbols has been created, the transmission device 10 inserts the normal skip ordered set that has the symbol length of four symbols between the data D_{—}1 to D_{—}8 and the data E_{—}1 to E_{—}8, respectively. Then, as illustrated at (H) in FIG. 12, when a negative slip is detected, i.e., when it is determined that the speed of the operation clock for the transmission device 10b is higher than that for the transmission device 10, the transmission device 10 performs the following process.

Namely, as illustrated at (I) in FIG. 12, the transmission device 10 creates a skip ordered set that has a length of three symbols and that is shorter than the normal length. Then, as illustrated at (J) in FIG. 12, after the SKP Ins instruction has been created, as illustrated at (K) in FIG. 12, the transmission device 10 simultaneously inserts the skip ordered set between the data F_{—}1 to F_{—}8 and the data G_{—}1 to G_{—}8, respectively, i.e., these insertions are made at the boundaries of the data. Then, as illustrated at (L) in FIG. 12, because the transmission device 10 inserts a skip ordered set that has a length of three symbols, the transmission device 10 creates a skip ordered set that has the normal length of four symbols.

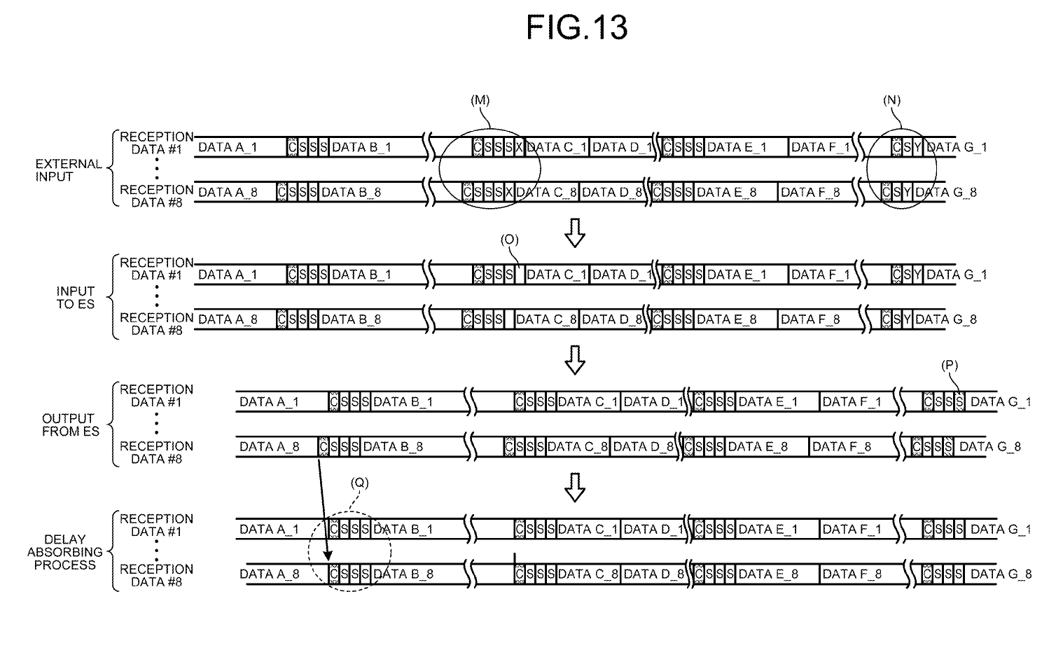

In the following, how a process is performed on the skip ordered set that has been transmitted to the transmission device 10b will be described with reference to FIG. 13. FIG. 13 is a schematic diagram illustrating a process performed on a skip ordered set by the transmission device on the reception side according to the first embodiment. FIG. 13 illustrates the reception data #1 to #8 that are received by the transmission device 10b, the reception data #1 to #8 each of which is stored in an elastic buffer by the transmission device 10b, and the reception data #1 to #8 each of which is read from the corresponding elastic buffer. Furthermore, FIG. 13 illustrates the nature of the deskewing process performed by the transmission device 10b. Furthermore, in FIG. 13, the “COM” symbol is represented by “C”, a normal “SKP” symbol is represented by “S”, an added “SKP” symbol is represented by “X”, and the “SKP” symbol that is duplicated by being read twice is represented by “Y”.

For example, as illustrated at (M) in FIG. 13, a skip ordered set that has a length of five symbols is inserted between the data B_{—}1 to B_{—}8 and the data C_{—}1 to C_{—}8, respectively. Furthermore, as illustrated at (N) in FIG. 13, a skip ordered set that has a length of three symbols is inserted between the data F_{—}1 to F_{—}8 and the data G_{—}1 to G_{—}8, respectively.

Consequently, as illustrated at (O) in FIG. 13, when the transmission device 10b stores each of the transmission data #1 to #8 in an elastic buffer, the transmission device 10b deletes the last symbol “X” in the skip ordered set and corrects the skip ordered set to a skip ordered set that has a length of four symbols. Furthermore, as illustrated at (P) in FIG. 13, when the transmission device 10b reads each of the transmission data #1 to #8 from the corresponding elastic buffer, the transmission device 10b reads the last symbol “Y” in the skip ordered set twice and duplicates the symbol, thereby correcting the skip ordered set to a skip ordered set that has a length of four symbols.

Furthermore, as illustrated at (Q) in FIG. 13, by delaying the transmission data #8, the transmission device 10b performs the deskewing process in which the positions of “COM” in the skip ordered sets inserted into the transmission data #1 to #8 are aligned. Specifically, the transmission device 10b can perform the deskewing process without detecting the number of skip ordered sets that are inserted into the transmission data #1 to #8 nor comparing the skip ordered sets.

### Advantage of the First Embodiment

As described above, the transmission device 10 transmits multiple transmission data #1 to #8 to the transmission device 10b via different paths. At this point, the transmission device 10 compares the speed of the operation clock for the transmission device 10 with that for the transmission device 10b.

When the transmission device 10 determines that the speed of the operation clock for the transmission device 10 is higher than that for the transmission device 10b, the transmission device 10 inserts, into each of the transmission data #1 to #8, a skip ordered set that has a length of five symbols and that is longer than the normal skip ordered set. Furthermore, when the transmission device 10 determines that the speed of the operation clock for the transmission device 10b is higher than that for the transmission device 10, the transmission device 10 inserts, into each of the transmission data #1 to #8, a skip ordered set that has a length of three symbols and that is shorter than the normal skip ordered set. Consequently, the transmission device 10 can absorb a difference between the speed of the operation clock for the transmission device 10 and the operation clock for the transmission device 10b.

Furthermore, simply by correcting the symbol length of the skip ordered set inserted into each of the transmission data #1 to #8 to a length of four symbols that is the normal symbol length, the transmission device 10b can align the symbol length of the skip ordered set that is inserted into each of the transmission data #1 to #8. Consequently, because the transmission device 10 does not need to perform detection or comparison of the symbol length of a skip ordered set in the deskewing process performed on the transmission device 10b, the transmission device 10 can use a simplified logic in the deskewing process. Furthermore, by simplifying the logic of the deskewing process, the transmission device 10 can reduce the size of its circuit and the verification or the design of the circuit can be simplified.

Furthermore, the transmission device 10 includes the gray code counter 22b that periodically operates in accordance with its own operation clock and the gray code counter 22a that periodically operates in accordance with the operation clock for the transmission device 10b. When the value of the gray code counter 22b becomes “0”, the transmission device 10 acquires the value of the gray code counter 22a and then determines whether the acquired value is greater than that acquired immediately previously, whereby the transmission device 10 compares its own operation clock with the operation clock for the transmission device 10b. Consequently, even when the difference between the operation clock for the transmission device 10 and the operation clock for the transmission device 10b is small, the transmission device 10 can appropriately change the skip ordered set that is to be inserted into each of the transmission data #1 to #8 on the basis of the accumulated difference.

Furthermore, the transmission device 10 detects a skip ordered set from the received data and, when the length of the detected skip ordered set is shorter than that of the normal skip ordered set, the transmission device 10 duplicates a part of the skip ordered set. Furthermore, when the detected skip ordered set is longer than a predetermined skip ordered set, the transmission device 10 deletes a part of the skip ordered set. Consequently, the transmission device easily absorbs any difference between its own operation clock and the operation clock for the transmission device 10b.

### [b] Second Embodiment

In the first embodiment described above, a description has been given of the transmission device 10 that inserts, into each of the transmission data #1 to #8, a skip ordered set that has a different length of symbols depending on the difference between the operation clock for the transmission device 10 and that for the transmission device 10b; however, the embodiment is not limited thereto. For example, the transmission device 10 may also insert a different type of skip ordered set. In the following, a description will be given by assuming that a transmission device at the transmission source of the transmission data #1 to #8 is a transmission device 10h and a transmission device at the transmission destination thereof is a transmission device 10i.

For example, when there is no difference between the operation clock for the transmission device 10h and the operation clock for the transmission device 10i according to the second embodiment, the transmission device 10h simultaneously inserts, into each of the transmission data #1 to #8, a skip ordered set that has a length of four symbols, i.e., one “COM” symbol and three “SKP” symbols. Furthermore, when the speed of the operation clock for the transmission device 10h is higher than that for the transmission device 10i that is the destination of the transmission data #1 to #8, the transmission device 10h performs the following process.

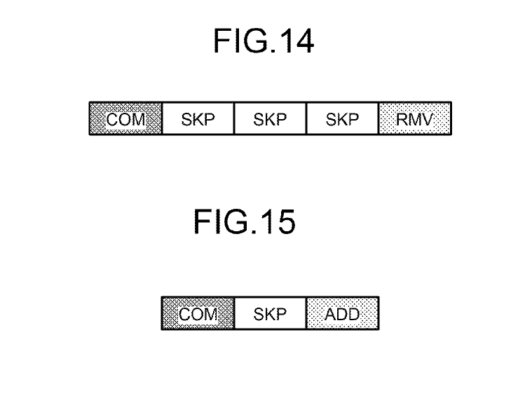

Namely, as illustrated in FIG. 14, the transmission device 10h creates a skip ordered set that has a length of five symbols in which a symbol “RMV” that is deleted when the transmission device 10i stores transmission data in an elastic buffer is added to a set of one “COM” symbol and three “SKP” symbols. Then, the transmission device 10h simultaneously inserts the created skip ordered set into each of the transmission data #1 to #8. FIG. 14 is a schematic diagram illustrating an example of a skip ordered set that is inserted when the speed of an operation clock for a transmission device according to a second embodiment is higher than that at the transmission destination.

Furthermore, when the speed of the operation clock for the transmission device 10i is higher than that for the transmission device 10h, the transmission device 10h performs the following process. Namely, as illustrated in FIG. 15, the transmission device 10h creates a skip ordered set in which, in addition to one “COM” and one “SKP”, a symbol “ADD” that is duplicated when the transmission device 10h reads the symbol from a buffer is included. Then, the transmission device 10h simultaneously inserts the created skip ordered set into each of the transmission data #1 to #8. FIG. 15 is a schematic diagram illustrating an example of a skip ordered set that is inserted when the speed of an operation clock for the transmission device according to the second embodiment is lower than that at the transmission destination.

In such a case, the transmission device 10i can easily correct the skip ordered set. Specifically, when storing each of the transmission data #1 to #8n an elastic buffer, the transmission device 10i detects only the symbol “RMV” that is inserted into each of the transmission data #1 to #8 and deletes the detected “RMV” without counting the number of skip ordered sets. Furthermore, when reading each of the transmission data #1 to #8 from the corresponding elastic buffer, the transmission device 10i detects only the symbol “ADD” and converts the detected “ADD” to two “SKP” symbols.

As described above, when the transmission device 10h simultaneously inserts the skip ordered set illustrated in FIG. 14 and FIG. 15 into each of the transmission data #1 to #8, it is enough that the transmission device 10i detects two types of symbol instead of detecting the length of symbols in a skip ordered set. Consequently, the transmission device 10h further simplifies the process for absorbing a difference between two operation clocks.

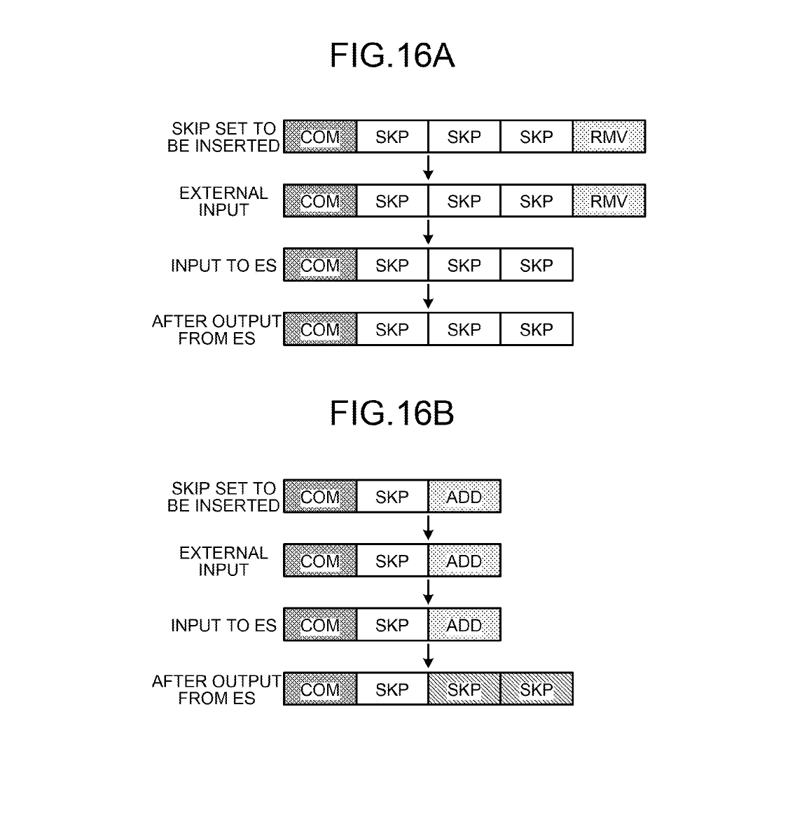

In the following, how a process is performed by the transmission device 10i on a skip ordered set that is simultaneously inserted into each of the transmission data #1 to #8 by the transmission device 10h will be described with reference to FIGS. 16A and 16B. FIG. 16A is a schematic diagram illustrating an example of a skip ordered set that is inserted when the speed of an operation clock for the transmission device on the transmission side according to the second embodiment is higher than that for the transmission device on the reception side.

In the example illustrated in FIG. 16A, the transmission device 10h simultaneously inserts, into each of the transmission data #1 to #8, a skip ordered set that has one “COM” symbol, three “SKP” symbols, and one “RMV” symbol. In such a case, when storing each of the transmission data #1 to #8 in an elastic buffer, the transmission device 10i detects “RMV” and then deletes the detected “RMV”.

In contrast, FIG. 16B is a schematic diagram illustrating an example of a skip ordered set that is inserted when the speed of an operation clock for the transmission device on the reception side is higher than that for the transmission device on the transmission side. In the example illustrated in FIG. 16B, the transmission device 10h simultaneously inserts, into each of the transmission data #1 to #8, the skip ordered set that has one “COM” symbol, one “SKP” symbol, and one “ADD” symbol.

In such a case, the transmission device 10i stores each of the transmission data #1 to #8 in an elastic buffer and then detects, when each of the transmission data #1 to #8 is read, only the “ADD” symbol. Then, the transmission device 10i converts the detected “ADD” symbol to two “SKP” symbols.

In order to define such a skip ordered set, the disparities in the transmission device 10i and the transmission device 10h are defined to be neutral codes. Specifically, when performing serial transmission using PCIe, data is converted from 8-bit data to 10-bit data at the time of transmission and the converted data is decoded from 10-bit data to 8-bit data at the time of reception. At this point, in a single 8-bit code, two types of associated 10-bit codes (Current RD− and Current RD+) are present, one of the codes is selected depending on the content of the 10-bit code obtained in the immediately previous encoding process.

Here, the rule of disparity in an 8B/10B encoding process is set out. Specifically, on the transmission side, after the power supply is turned on, the initial value of the running disparity is set to negative (−). Then, the transmission side calculates the value of a new running disparity on the basis of the content of the transmitted 10-bit code. When the number of “1s” is greater than that of “0s” in the data bits that have been transmitted, the running disparity is positive (+), whereas when the number of “0s” is greater than that of “1s”, the running disparity is negative (−). Furthermore, when the number of “0s” in the data bits that have been transmitted is the same as that of the “1s”, i.e., when they are neutral, the running disparity does not vary. Under this rule, when the transmission side converts an 8-bit code to a 10-bit code, the transmission side selects the 10-bit code in accordance with the running disparity.

In contrast, on the reception side, after the power supply is turned on, it is conceivable that the initial value of the running disparity is either positive (+) or negative (−). The reception side determines whether the received 10-bit code is valid or invalid and then calculates, on the basis of the content of the received 10-bit code, the value of the new running disparity. Furthermore, when the received 10-bit code is present in the current running disparity table, the reception side recognizes that the received 10-bit code is valid and then decodes the 10-bit code to an 8-bit code. In contrast, when the received 10-bit code is not present in the current running disparity table, the reception side recognizes that the received 10-bit code is invalid.

Under this rule, when the “ADD” symbol and the “RMV” symbol described above are not neutral codes, the running disparity varies when the “ADD” symbol or the “RMV” symbol is transmitted. In this state, when the “RMV” symbol is deleted on the reception side, because the running disparity does not vary, a disparity error may possibly occur in the symbol that is received subsequent to the “RMV” symbol. Consequently, the “ADD” symbol and the “RMV” symbol are defined to be codes having a neutral disparity.

### Advantage of the Second Embodiment

As described above, when the speed of the operation clock for the transmission device 10h is higher than that for the transmission device 10i, the transmission device 10h simultaneously inserts, into each of the transmission data #1 to #8, a skip ordered set in which a symbol that is to be deleted by the transmission device 10i is added to the skip ordered set that has a normal length of four symbols. Furthermore, when the speed of the operation clock for the transmission device 10i is higher than that for the transmission device 10h, the transmission device 10h simultaneously inserts, into each of the transmission data #1 to #8, a skip ordered set that has a length of three symbols, that is shorter than the normal length, and that includes a symbol duplicated by the transmission device 10i.

Consequently, because the transmission device 10h can absorb the difference between the operation clock for the transmission device 10h and the operation clock for the transmission device 10i on the reception side without correcting the length of the skip ordered set by the transmission device 10i, the transmission device 10h simplifies the logic of the deskewing process. Furthermore, the transmission device 10i can detect both the “RMV” symbol and the “ADD” symbol without detecting the length of symbols in a skip ordered set and can align, when a process is performed in accordance with the detected symbol, the lengths of the symbols in the skip ordered set that are inserted into the transmission data #1 to #8, respectively. Consequently, the transmission device 10h can further simplify the process, performed on the reception side, for aligning the lengths of the symbols in the skip ordered sets.

### [c] Third Embodiment

Each of the transmission devices 10 to 10i simplifies the process performed by the transmission device on the destination side; however, the embodiment is not limited thereto. For example, each of the transmission devices 10 to 10i may also further perform a process that simplifies the process that is performed when each of the transmission data #1 to #8 sent back by a loopback process is received. In the following, a description will be given by assuming that a transmission device at the transmission source of the transmission data #1 to #8 is a transmission device 10j and a transmission device at the transmission destination thereof is a transmission device 10k.

For example, when storing each of the transmission data #1 to #8 in an elastic buffer, each of the transmission device 10j and the transmission device 10k detects an “RMV” symbol and deletes the detected “RMV” symbol. Furthermore, when reading each of the transmission data #1 to #8 from the corresponding elastic buffer, each of the transmission device 10j and the transmission device 10k detects an “ADD” symbol and corrects the detected “ADD” symbol to the “SKP” symbol and to the “ADD” symbol. Furthermore, when reading each of the transmission data #1 to #8 from an elastic buffer, each of the transmission device 10j and the transmission device 10k detects the “ADD-r” symbol and corrects the detected “ADD-r” symbol to the “SKP” symbol and to the “RMV” symbol.

In other words, the “SKP” symbol mentioned here is a symbol that is neither added nor deleted. The “RMV” symbol mentioned here is a symbol that is deleted when the symbol is stored in an elastic buffer. The “ADD” symbol mentioned here is a symbol to which a single symbol that is neither added nor deleted when the symbol is read from an elastic buffer is added. The “ADD-r” symbol mentioned here is a symbol that is converted, when it is read from an elastic buffer, to a single symbol that is neither added nor deleted and converted to a single symbol that is deleted when the symbol is stored in an elastic buffer.

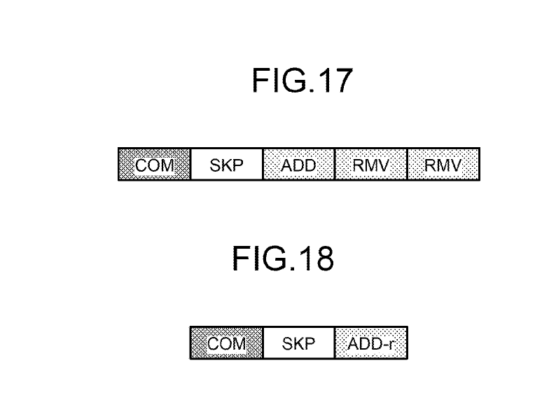

As illustrated in FIG. 17, the transmission device 10j that performs such a process described above creates, when the speed of the operation clock for the transmission device 10j is higher than that for the transmission device 10k, a skip ordered set that has a length of five symbols, i.e., the symbols “COM”, “SKP”, “ADD”, “RMV”, and “RMV”. Then, the transmission device 10j simultaneously inserts the created skip ordered set into each of the transmission data #1 to #8. FIG. 17 is a schematic diagram illustrating an example of a skip ordered set that is inserted when an operation clock for the transmission device according to a third embodiment is higher than that at the transmission destination.

Furthermore, as illustrated in FIG. 18, when the speed of the operation clock for the transmission device 10k is higher than that for the transmission device 10j, the transmission device 10j creates a skip ordered set that has a length of three symbols, i.e., the symbols “COM”, “SKP”, and “ADD-r”. Then, the transmission device 10j simultaneously inserts the created skip ordered set into each of the transmission data #1 to #8. FIG. 18 is a schematic diagram illustrating an example of a skip ordered set that is inserted when an operation clock for the transmission device according to the third embodiment is lower than that at the transmission destination.

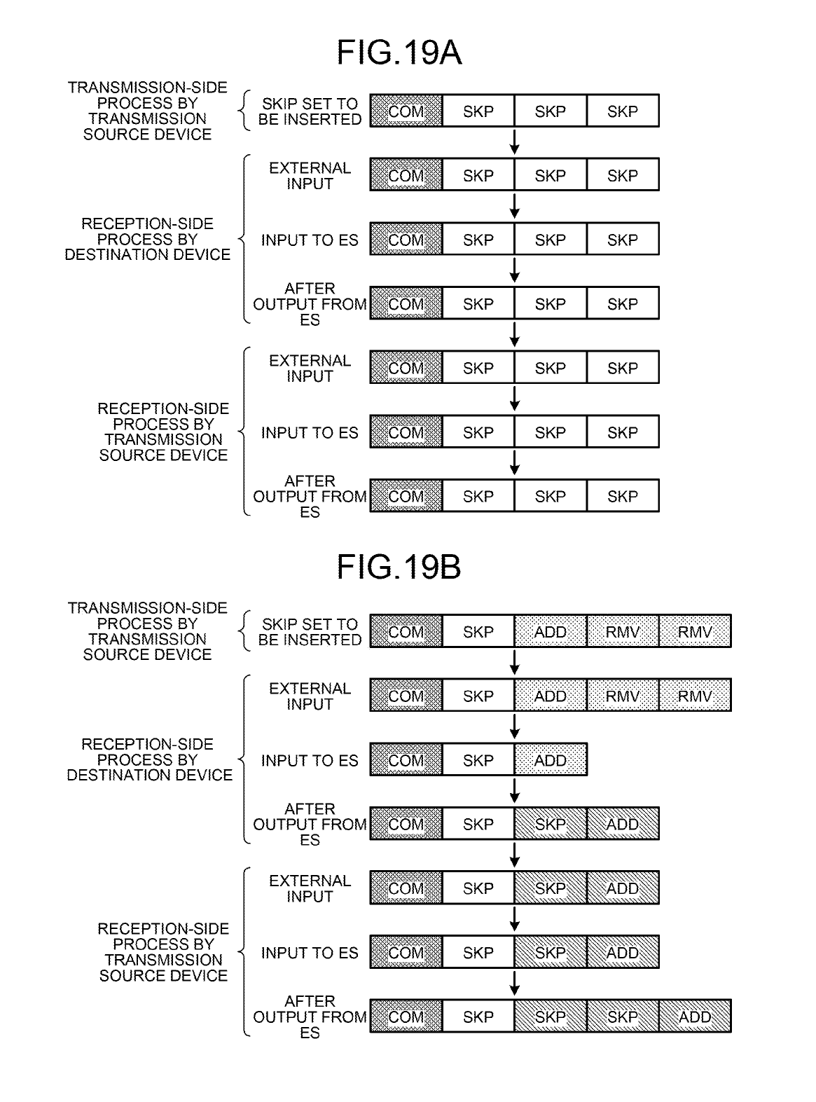

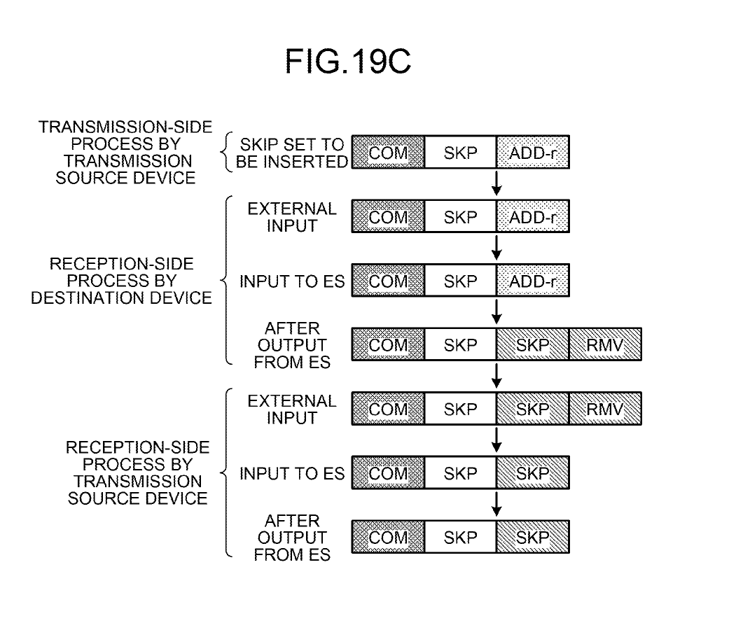

In the following, how the transmission device 10k performs a process on the skip ordered set that is simultaneously inserted into each of the transmission data #1 to #8 will be described with reference to FIGS. 19A, 19B, and 19C. FIG. 19A is a first schematic diagram illustrating how the transmission devices on the transmission side and the reception side according to the third embodiment perform a process on a skip ordered set. FIG. 19B is a second schematic diagram illustrating how the transmission devices on the transmission side and the reception side according to the third embodiment perform a process on a skip ordered set. FIG. 19C is a third schematic diagram illustrating how the transmission devices on the transmission side and the reception side according to the third embodiment perform a process on a skip ordered set.

FIGS. 19A to 19C illustrate examples of skip ordered sets inserted by the transmission device 10j as a transmission-side process. Furthermore, FIGS. 19A to 19C illustrate, as a reception-side process performed by the transmission device 10j, a skip ordered set that is input to the transmission device 10k on the destination side, a skip ordered set that is stored in an elastic buffer by the transmission device 10k, and a skip ordered set that is read from the elastic buffer by the transmission device 10k. Furthermore, FIGS. 19A to 19C illustrates a skip ordered set that is looped back to the transmission device 10j, a skip ordered set that is stored in an elastic buffer by the transmission device 10j, and a skip ordered set that is read from the elastic buffer by the transmission device 10j, which are all part of a reception-side process performed by the transmission device 10j.

As illustrated in FIG. 19A, the transmission device 10j on the transmission side simultaneously inserts, into each of the transmission data #1 to #8, a skip ordered set that includes therein “COM”, “SKP”, “SKP”, and “SKP”. In such a case, the transmission device 10k on the reception side does not delete nor add the “SKP” symbol when the transmission device 10k stores each of the transmission data #1 to #8 in an elastic buffer or when the transmission device 10k reads each of the transmission data #1 to #8 from the elastic buffer. Consequently, the transmission device 10j on the transmission side can acquire the transmission data #1 to #8 in each of which a skip ordered set that has the same length as that used at the time of transmission has been stored.

FIG. 19B is another schematic diagram illustrating how the transmission devices on the transmission side and the reception side according to the third embodiment perform a process on a skip ordered set. As illustrated in FIG. 19B, the transmission device 10j on the transmission side simultaneously inserts, into each of the transmission data #1 to #8, a skip ordered set that includes “COM”, “SKP”, “ADD”, “RMV”, and “RMV”. In such a case, the transmission device 10k on the reception side deletes two “RMV” symbols when the transmission device 10k stores each of the transmission data #1 to #8 in an elastic buffer.

Furthermore, when reading each of the transmission data #1 to #8 from an elastic buffer, the transmission device 10k corrects the “ADD” symbol to a “SKP” symbol and to the “ADD” symbol. Specifically, the transmission device 10k adds an “SKP” symbol. Then, the transmission device 10k loops back the transmission data #1 to #8 that are read from elastic buffers to the transmission device 10j.

In contrast, the transmission device 10j stores each of the looped back transmission data #1 to #8 in an elastic buffer. Then, when reading each of the transmission data #1 to #8 from an elastic buffer, the transmission device 10j corrects the “ADD” symbol to the “SKP” symbol and the “ADD” symbol. Consequently, the transmission device 10j can acquire the transmission data #1 to #8 in each of which stores therein a skip ordered set that has the same length of symbols, i.e., five symbols, as that inserted by the transmission device 10j.

FIG. 19C is still another schematic diagram illustrating how the transmission devices on the transmission side and the reception side according to the third embodiment perform a process on a skip ordered set. As illustrated in FIG. 19C, the transmission device 10j on the transmission side simultaneously stores a skip ordered set that includes “COM”, “SKP”, and “ADD-r” in each of the transmission data #1 to #8. In such a case, when reading each of the transmission data #1 to #8 from an elastic buffer, the transmission device 10k corrects the “ADD-r” symbol to the “SKP” symbol and to the “RMV” symbol. Then, the transmission device 10k loops back, to the transmission device 10j, each of the transmission data #1 to #8 read from the corresponding elastic buffer.

In contrast, when storing each of the looped back transmission data #1 to #8 in the corresponding elastic buffer, the transmission device 10j deletes the “RMV” symbol that is inserted into each of the transmission data #1 to #8. Then, the transmission device 10j acquires each of the transmission data #1 to #8 stored in the corresponding elastic buffer. Specifically, the transmission device 10j can acquire the transmission data #1 to #8 in each of which stores therein a skip ordered set that has the same length of symbols, i.e., three symbols, as that inserted by the transmission device 10j.

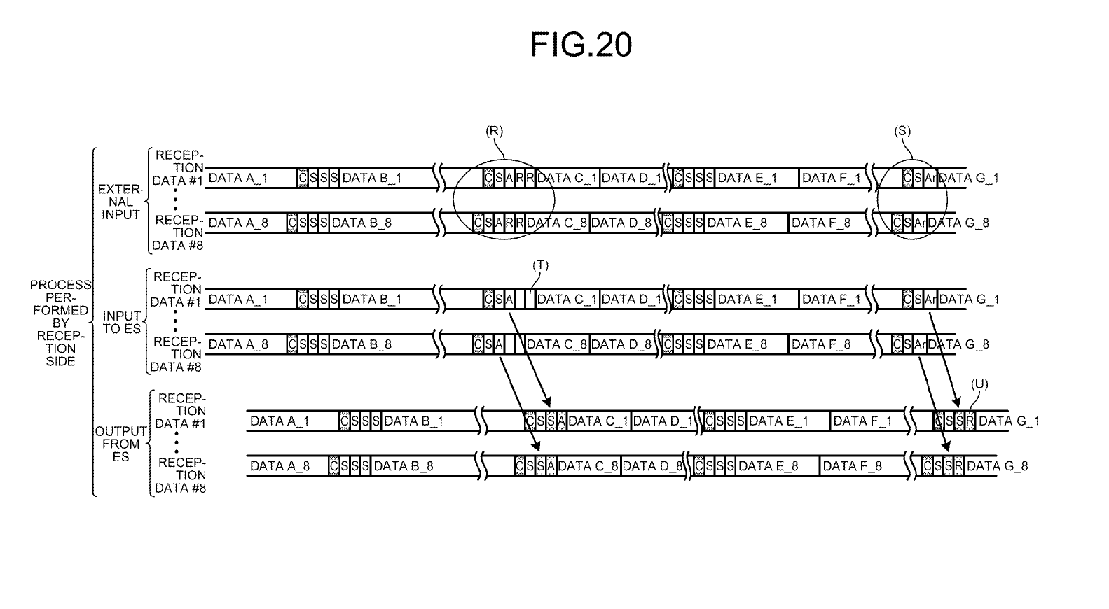

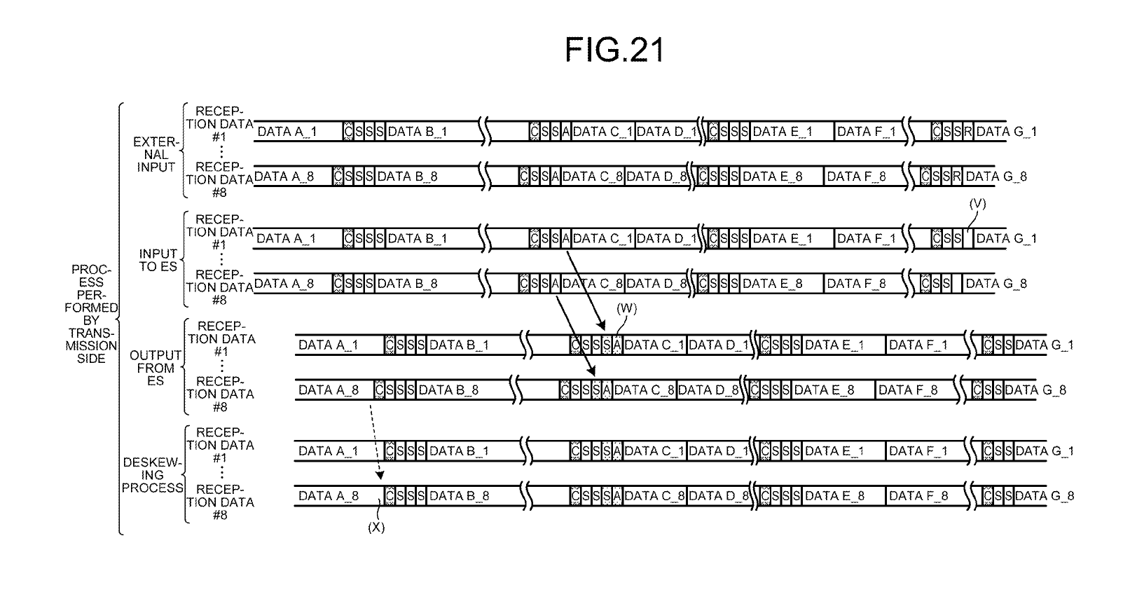

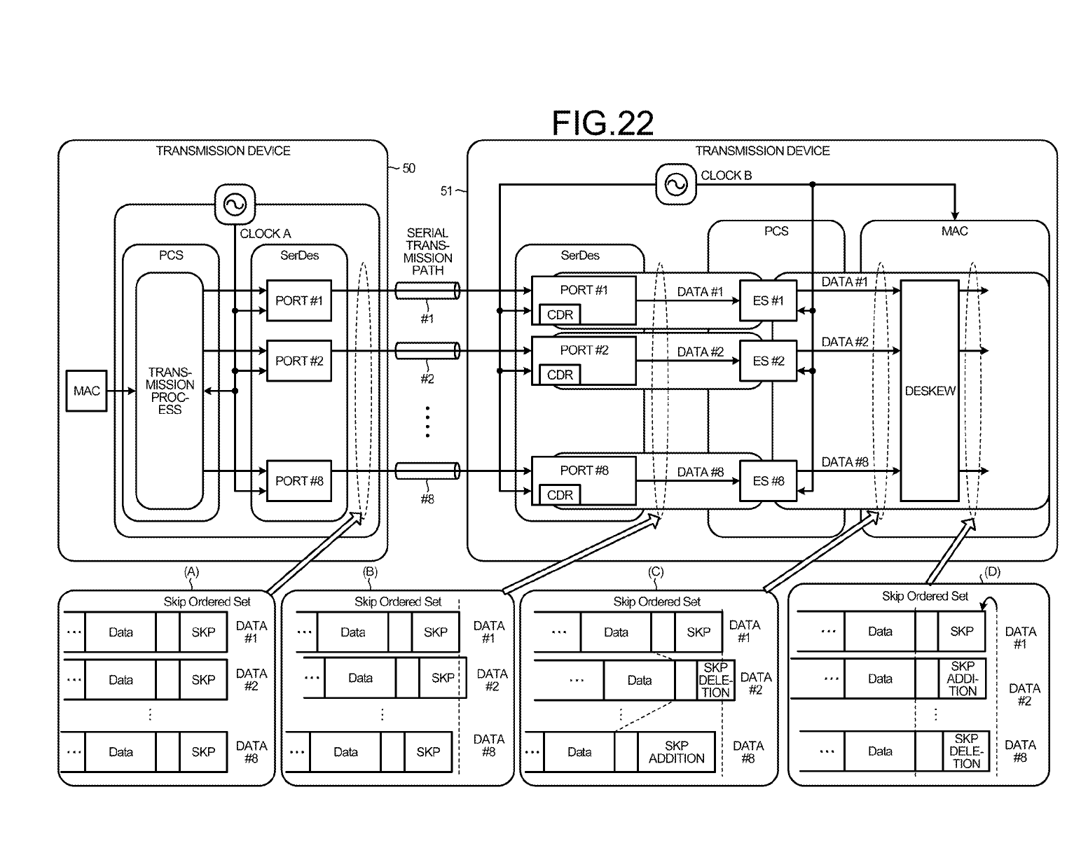

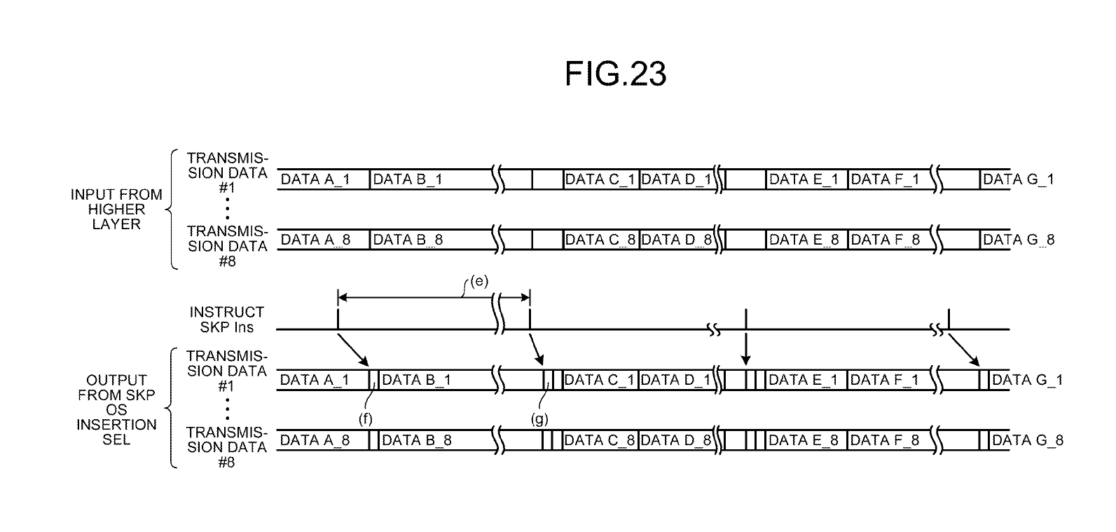

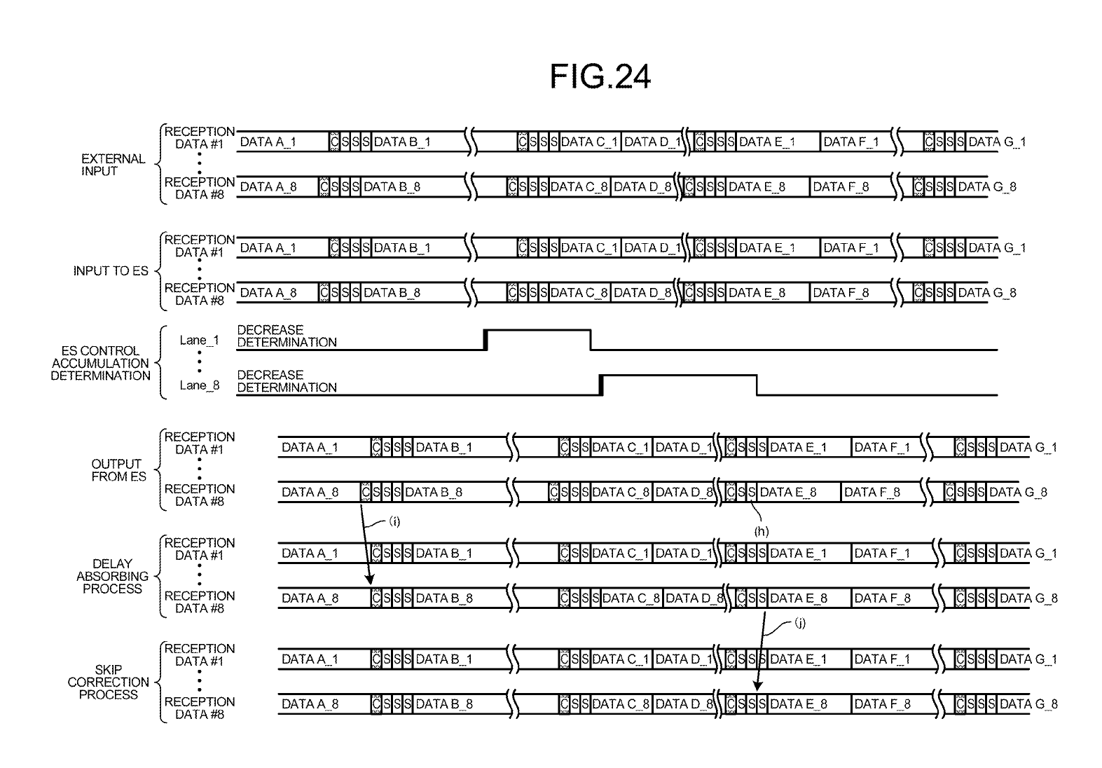

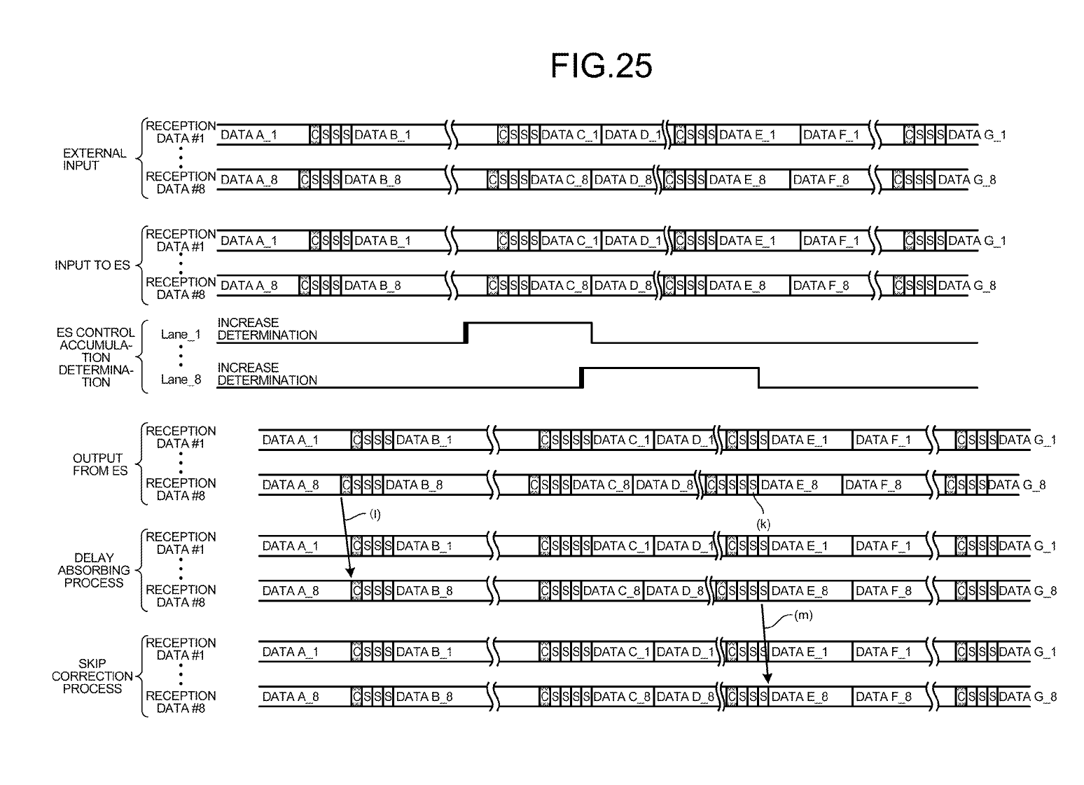

In the following, the flow of processes performed by the transmission device 10j and the transmission device 10k will be described with reference to FIGS. 20 and 21. FIG. 20 is a schematic diagram illustrating the flow of a process performed by the transmission device on the reception side according to the third embodiment. FIG. 21 is a schematic diagram illustrating the flow of a process performed by the transmission device on the transmission side according to the third embodiment. In the example illustrated in FIGS. 20 and 21, the “COM” symbol is represented by “C”, the “SKP” symbol is represented by “S”, the “ADD” symbol is represented by “A”, the “RMV” symbol is represented by “R”, and the “ADD-r” symbol is represented by “Ar”.

First, an example of the flow of a process performed by the transmission device 10k will be described with reference to FIG. 20. FIG. 20 illustrates examples of the reception data #1 to #8 that have been received from the transmission device 10j by the transmission device 10k, the reception data #1 to #8 each of which is stored in an elastic buffer by the transmission device 10k, and the reception data #1 to #8 that are read from the corresponding elastic buffer by the transmission device 10k.

The transmission device 10k acquires the reception data #1 to #8 in each of which includes therein a skip ordered set including the “RMV” symbol, as illustrated at (R) in FIG. 20, and a skip ordered set including the “ADD-r” symbol, as illustrated at (S) in FIG. 20. In such a case, as illustrated at (T) in FIG. 20, the transmission device 10k discards the “RMV” symbol when the transmission device 10k stores each of the reception data #1 to #8 in the corresponding elastic buffer. Furthermore, as illustrated at (U) in FIG. 20, when reading each of the reception data #1 to #8 from the corresponding elastic buffer, the transmission device 10k converts the “ADD-r” symbol to the “SKP” symbol and to the “RMV” symbol.

In the following, an example of the flow of a process performed by the transmission device 10j will be described with reference to FIG. 21. FIG. 21 illustrates an example of the reception data #1 to #8 that are received by the transmission device 10j and that are looped back from the transmission device 10k and also illustrates an example of the reception data #1 to #8 that are stored in each of the elastic buffers by the transmission device 10j. Furthermore, FIG. 21 illustrates an example of reception data #1 to #8 that are read from the corresponding elastic buffer by the transmission device 10j and illustrates an example of the reception data #1 to #8 subjected to the deskewing process performed by the transmission device 10j.

In the example illustrated in FIG. 21, the transmission device 10j acquires the reception data #1 to #8, illustrated in FIG. 20, each of which is read from the corresponding elastic buffer by the transmission device 10k. Then, as illustrated at (V) in FIG. 21, when writing each of the reception data #1 to #8 to the corresponding elastic buffer, the transmission device 10j deletes the “RMV” symbol.

Then, as illustrated at (W) in FIG. 21, when reading each of the reception data #1 to #8 from the corresponding elastic buffer, the transmission device 10j converts the “ADD” symbol to the “ADD” symbol and to the “SKP” symbol. Consequently, the transmission device 10j can correct the number of symbols in the skip ordered set that was inserted into each of the looped back reception data #1 to #8 to the same number of symbols in the skip ordered set that was inserted by the transmission device 10j.

Then, as illustrated at (X) in FIG. 21, the transmission device 10j performs a deskewing process that aligns the positions of the “COM” symbols inserted into the reception data #8 and the positions of the “COM” symbols inserted into the other reception data #1 to #7. In this way, for each of the looped back reception data #1 to #8, the transmission device 10j can simply also perform the deskewing process without detecting the number of symbols in each of the skip ordered sets and correcting the symbols.

Similarly to the “RMV” symbol and the “ADD” symbol according to the second embodiment, the “ADD” symbol, the “RMV” symbol, and the “ADD-r” symbol according to the third embodiment are defined as a code having a neutral disparity.

### Advantage of the Third Embodiment

As described above, when the speed of the operation clock for the transmission device 10j is higher than that for the transmission device 10k, the transmission device 10j simultaneously inserts, into each of the transmission data #1 to #8, a skip ordered set in which “COM”, “SKP”, “ADD”, “RMV”, and “RMV” symbols are included. Furthermore, when the speed of the operation clock for the transmission device 10k is higher than that for the transmission device 10j, the transmission device 10j simultaneously inserts, into each of the transmission data #1 to #8, a skip ordered set in which the “COM”, “SKP”, and “ADD-r” symbols are included.

Consequently, the transmission device 10j can absorb the difference between the operation clock for the transmission device 10j and the operation clock for the transmission device 10k. Furthermore, simply by detecting the “ADD” symbol and the “RMV” symbol and without performing a complicated process, the following advantage can be provided for the transmission device 10j. Namely, the transmission device 10j can makes the number of symbols in the skip ordered set that is inserted into each of the transmission data #1 to #8 that is sent back by a loopback process and the number of symbols in the skip ordered set inserted by the transmission device 10j the same. Furthermore, the transmission device 10j simply performs the deskewing process on the transmission data #1 to #8 that are sent back by the loopback process.

Furthermore, the transmission device 10j can simplify the deskewing process in the transmission device 10k. Consequently, when performing the loopback process, the transmission device 10j can make the logic of the deskewing process on the transmission side and the reception side simple and reduce the size of its circuit and the verification or the design of the circuit can be simplified. Furthermore, the transmission device 10j can reduce any delay in the deskewing process.

Furthermore, when performing a loopback process, the transmission device 10k can transmit, to the transmission device 10j without comparing the operation clock for the transmission device 10k with the operation clock for the transmission device 10j that is the destination, data into which an appropriate skip ordered set is inserted. Consequently, the transmission device 10j can further reduce the size of the circuits in the transmission devices 10j and 10k.

### [d] Fourth Embodiment

In the above explanation, a description has been given of the embodiments according to the present invention; however, the embodiments are not limited thereto and can be implemented with various kinds of embodiments other than the embodiments described above. Therefore, another embodiment will be described as a fourth embodiment below.

(1) The Number of Transmission Paths

In the embodiments described above, the descriptions have been given with the assumption that each of the transmission devices 10 to 10k described above are connected to the other transmission devices via eight serial links. However, the embodiments are not limited thereto. For example, each of the transmission devices 10 to 10k may also be connected to the other transmission devices via an arbitrary number of transmission paths.

(2) Symbol

Each of the transmission devices 10 to 10k described above defines the “COM” symbol, the “SKP” symbol, the “ADD” symbol, the “RMV” symbol, and the “ADD-r” symbol as the symbols to be stored in a skip ordered set; however, the embodiment is not limited thereto. For example, any symbol may also be defined as long as, when each of the transmission devices 10 to 10k detects a symbol, the same process as that performed in the first, second, and third embodiments is performed.

According to an aspect of an embodiment, the logic of the deskewing process performed by a transmission device on the reception side is simplified.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a plurality of transmitting units that transmit data to an opposing device via different paths;
a determining unit that compares a first speed of an operation clock for the opposing device with a second speed of an operation clock for the transmission device to determine which of the operation clock speeds is higher; and
an inserting unit that inserts, when the determining unit determines that the first speed is same as the second speed, first difference absorbing data that has a predetermined data length into the data to be transmitted by each of the transmitting units, that inserts, when the determining unit determines that the first speed is higher, second difference absorbing data that has a data length smaller than the predetermined data length into the data to be transmitted by each of the transmitting units, and that inserts, when the determining unit determines that the second speed is higher, third difference absorbing data that has a data length greater than the predetermined data length into the data to be transmitted by each of the transmitting units.

2. The transmission device according to claim 1, wherein
the first difference absorbing data includes a symbol that is not deleted nor duplicated by the opposing device,
the second difference absorbing data includes a symbol that is duplicated by the opposing device, and
the third difference absorbing data is obtained by adding a symbol that is deleted by the opposing device to the first difference absorbing data.

3. The transmission device according to claim 2, further comprising a buffer that
stores therein data sent back by the opposing device,
when the second difference absorbing data is included in the stored data on reading out the stored data, deletes a symbol included in the second difference absorbing data, and
when the third difference absorbing data is included in the stored data on reading out the stored data, duplicates a symbol included in the third difference absorbing data.

4. The transmission device according to claim 1, wherein
the determining unit includes
a first counter that operates in accordance with the operation clock for the transmission device,
a second counter that operates in accordance with the operation clock for the opposing device, and
a deciding unit that acquires, when a value of the first counter becomes a predetermined value, a value of the second counter, that compares the value acquired from the second counter with a value acquired immediately previously from the second counter, that decides, when it is determined that the value acquired this time is greater than the value acquired immediately previously, that the first speed is higher and that decides, when it is determined that the value acquired immediately previously is greater than the value acquired this time, that the second speed is higher.

5. A transmission device comprising:
a receiving unit that receives data from an opposing device;
a detecting unit that detects, from the data received by the receiving unit, difference absorbing data that is used to absorb a difference between an operation clock for the opposing device and an operation clock for the transmission device; and
a difference absorbing unit that deletes, when the difference absorbing data detected by the detecting unit has a data length greater than a predetermined data length, a part of the difference absorbing data and that duplicates, when the difference absorbing data detected by the detecting unit has a data length smaller than the predetermined data length, a part of the difference absorbing data.

6. A transmission system comprising:
a transmission device that transmits, to an opposing device via multiple paths, data into which difference absorbing data that absorbs a difference between an operation clock for the opposing device and an operation clock for the transmission device is inserted; and
the opposing device that receives the data transmitted by the transmission device, wherein
the transmission device includes
a plurality of transmitting units that transmit the data to the opposing device via different paths,
a determining unit that compares a first speed of an operation clock for the opposing device with a second speed of an operation clock for the transmission device to determine which of the operation clock speeds is higher, and
an inserting unit that inserts, when the determining unit determines that the first speed is same as the second speed, first difference absorbing data that has a predetermined data length into the data to be transmitted by each of the transmitting units, that inserts, when the determining unit determines that the first speed is higher, second difference absorbing data that has a data length smaller than the predetermined data length into the data to be transmitted by each of the transmitting units, and that inserts, when the determining unit determines that the second speed is higher, third difference absorbing data that has a data length greater than the predetermined data length into the data to be transmitted by each of the transmitting units.

7. A control method performed by a transmission device that transmits, via multiple paths, data to an opposing device that stores the data in a buffer and that reads the data stored in the buffer, the control method comprising:
comparing a first speed of an operation clock for the opposing device with a second speed of an operation clock for the transmission device to determine which of the operation clock speeds is higher; and
inserting, when it is determined that the first speed is same as the second speed, first difference absorbing data that has a predetermined data length into the data to be transmitted, inserting, when it is determined that the first speed is higher, second difference absorbing data that has a data length smaller than the predetermined data length into the data to be transmitted, and inserting, when it is determined that the second speed is higher, third difference absorbing data that has a data length greater than the predetermined data length into the data to be transmitted.
